(19) United States
(12) Patent Application Publication
(10) Pub. No.: US 2007/0082093 A1
(43) Pub. Date: Apr. 12, 2007

(54) Method for preparing film coatings and film coating

(75) Inventors: Jouko Savolainen, Espoo (FI); Jyrki Heinamaki, Heisinki (FI); Jouko Yliruusi, Vantaa (FI)

Correspondence Address: FAY SHARPE LLP, 1100 SUPERIOR AVENUE, SEVENTH FLOOR, CLEVELAND, OH, 44114, US

(73) Assignee: UNIQ BIORESEARCH OY, Espoo (FI)

(21) Appl. No.: 10/575,400

(22) PCT Filed: Oct. 15, 2004
(86) PCT No.: PCT/FI04/00619

§ 371 Date: Apr. 7, 2006

(30) Foreign Application Priority Data
Oct. 15, 2003 (FI) 20031506
Oct. 15, 2003 (FI) 20031508

(51) Int. Cl. A23L 1/315

(52) U.S. Cl. 426/140

(57) ABSTRACT

The disclosure pertains to a method for preparing a protein-based film wherein modified protein containing free sulfhydryl groups is added to a solution containing protein and the free sulfhydryl groups cause an interchange reaction wherein disulfide bonds will be formed between proteins to form a film structure to coat a product. The disclosure also pertains to a protein-based film.

The present invention relates to a method for preparing protein-based film coatings, microcapsules and related and capsulation of solid substrates. The present invention also relates to protein-based film coatings.

### BACKGROUND OF THE INVENTION

Application of Whey Proteins as Film Formers

During recent decades, an increased interest has been focused on application of protein-based films in protection of food and other nutrient products. These films are designed as edible coats, capable of being digested in human GI-tract, and biodegradable in the nature. With the present type of films, the extensive use of synthetic non-biodegradable packaging materials can be avoided.

The first edible films based on proteins were prepared from proteins of vegetable origin. These films were aimed to increase the storage stability of the products by decreasing the water evaporation (drying), by decreasing oxygen transmission, and by decreasing the microbiological contamination. Glutein isolated from wheat and zein from corn were proteins most widely used for this purpose. The films were prepared by dissolving proteins to ethanol, and glycerol was used as a plasticizer. The mixture was heated up to 75-77° C. Prior to casting the films, the mixture was allowed to cool. After casting, the films were dried at 35° C. for at least 15 hours, and subsequently peeled from the molds. The films prepared from glutein and zein resisted oxygen and carbon dioxide, but they were readily permeable for moisture, and this feature was dependent on the environmental relative humidity (Aydt et al. 1991, Gennadois et al. 1993).

The high permeability for water was decreased by incorporating various lipids or lipophilic compounds into the films. The best results were obtained with diacetyltartaric esters of monoglycerides, since the use of this compound resulted in increased mechanical strength of the films and transparency of the films (Gontard et al. 1994).

According to the U.S. Pat. No. 4,720,390, whey protein forms a gel in 4-12% (w/w) solution in food products and this solution can be incorporated with lipids from 2.5% to 40% (v/v). By increasing the amount of lipids/oil to certain limit, the amount of protein needed in gel formation will be decreased. Prerequisite for successful gel formation is that the protein is heated up to 90° C. for at least 30 minutes in neutral solution. Sugars such as dextrose, lactose and saccharose and additionally spices, salts and preservatives can be included in the mixture.

Gel formation and consistency of the gel are greatly dependent on the concentration of whey proteins and heat treatment (e.g. temperature and time). As a result of the SH—/SS interchange reaction, disulfide (SS) bonds are formed. These covalent bonds are the most important binding forces affecting to the consistency of the gel (Shimada and Cheftel 1988).

WO 97/33906 discloses wheat gluten protein-based biodegradable or edible films made of modified wheat gluten having substantially no heat denaturation. Dispersion is used for preparing the films, said dispersion containing a plasticizer and a member for promoting the dispersion. Examples of said members provided are all alkaline resulting in high pH (8-12). As a consequence the sulfonate derivatives formed in the film forming reaction will stay in the film rendering the use of such film doubtful in food products or the like.

According to another U.S. Pat. 5,543,164, protein films can be prepared from whey protein solution by treating the solution to form a denatured protein solution. Said solution is substantially free of sugars. The treating may be heat treatment from 15 minutes up to 3 hours or a chemical treatment. However, no examples of chemical treatment and methods thereof are provided. All the experiments were carried out with heat treatment of proteins. The heat treatment was considered essential to obtain films with acceptable mechanical strength. Plasticizer such as glycerol, sorbitol or polyethylene glycol may also be added (2-10% of the solution weight). Furthermore, lipids/oils or lipophilic compounds at concentration of 2-15% (w/w) can be incorporated by heating the lipid until it is fluid and by homogenizing it to obtain an emulsion. The primary function of the lipids is to prevent permeation of water, oxygen, carbon dioxide, lipids and flavoring agents.

Protein solution can be poured (or casted) onto the molds, and by drying the solution with a proper method, film with a certain thickness will be obtained. The drying phase will generally take about 18 hours at a room temperature. When drying the solution forms a film that is not water soluble, and possible free SH groups will oxidize to SS groups/bonds. Oxidization can be enhanced by using oxygen of the air or oxidizing agent.

By using proper methods, protein solution can be spread onto the surface of the food and after drying the uniform film will be formed as described in WO9319615. Formation of the films can be promoted as described previously.

The main limitation associated when forming the edible protein films is that native proteins of vegetable origin are virtually insoluble in water. Whey proteins, however, are very water soluble, but main limitation related to use of whey proteins is the preparation of the film forming solution. In the art it is known essential to heat the solution at least to 90° C. for 30 minutes in order to obtain films of good quality.

By heating the protein solution, disulfide bonds that are considered as important binding forces within the film structure, are formed, and the added sulfhydryl (SH) groups will accelerate the present formation. Application of chemical substances such as mercaptoethanol, cysteine, dithiotreitol or sulfite, is not possible in food, or application of these substances has been restricted as regards the amount, or their methods of application and processes are unknown.

The modification of whey proteins by heating results in formation of lysinoalanine in neutral or alkaline medium. Consequently, the nutritional value of the protein will decrease and lysinoalanine may cause harmful side effects. Heating proteins with sugars (with i.e. aldehyde group containing glucose or lactose) results in chemical compounds that are formed at the beginning of Maillard reaction. These compounds include Amadori compound that may cause decrease in nutritional value of the protein, and the compound formed may be allergenic (Friedman 1994). The method described above involves one difficult step, in which the dissolved gases are removed from the solution in vacuum conditions in order to avoid any gas bubbles that may increase the permeability of the films for moisture and oxygen.

Application of Whey Proteins in Emulsions and Microencapsulation

The first description of whey proteins as emulsifying agents with lipids and lipophilic substances is presented in U.S. Pat. No. 4,790,998. With the patented method, it was possible to produce microcapsules with a mean diameter of 1 μm from oils that also contained aromatic compounds or were aromatic themselves (e.g. citrus oil). The microcapsules were used as an artificial clouding agent in acidic beverage. Emulsions were made from the native whey protein concentrate (protein content 55%). The whey protein content of the solution was 7.6% (w/w), soya oil content 4.5% (w/w) and pH was adjusted to 2.2. Solution was heated to 75° C. for 5 minutes, and after that it was homogenized in two steps (4500 psi and 500 psi). After homogenization, emulsion was cooled down to 20° C. Emulsion was used in acidic beverages to obtain cloudy final solution. Emulsion was also spray dried or freeze dried in preparing microcapsules, and the present solid microcapsules were used in redispersible powders for beverages.

In U.S. Pat. No. 5,601,760, application of native whey proteins, whey protein concentrate and isolate, and β-lactoglobulin and mixture of β-lactoglobulin and α-lactalbumin as emulsifying agents with lipids, oils and the other lipophilic compounds in preparing microcapsules is described.

Amount of whey protein and lactose or other carbohydrate (e.g. concentration of the emulsifying or microencapsulating agent) in the solution varies generally from 10% to 30% (w/w). The amount of substance or mixture of substances that are microencapsulated can vary from 5% to 95% (w/w) and the amount of milk lipid from 25% to 75% (w/w) calculated from the emulsifying agent weight.

Alternatively, it is preferred that the amount of the emulsifying agent (e.g. whey protein isolate) is about 10% (w/w) calculated from the solution weight. The solution may be heated, for example to 80° C., for 30 minutes and after that it is emulsified by homogenizing.

Temperature of the mixture is increased depending on the properties of the lipid component up to 60° C. and air is removed by vacuum. After this the emulsion can be prepared in two phases. In the first step, lipid is dispersed in the solution by homogenizer and after that the mixture is homogenized using the pressure of 25-80 MPa several times so that the final mean droplet size will be >1 μm. Emulsion may be spray dried by using the inlet temperature of 160° C. and outlet temperature of 80° C.

Film coating of nuts and seeds would be an interesting way to improve e.g. appearance, taste, smell and stability characteristics of the final product. In the literature, a very limited number of papers have been published on the present type of applications. The main reasons for this may be the difficulties related to the coating process (Mate et al. 1996).

Pharmaceutical Film Coating

In the field of pharmacy, film coating is an effective way of providing physical and chemical protection, masking or controlled release rate (or site) of an active therapeutical ingredient (ATI). The essential component in a pharmaceutical film coating formulation is a coating agent, which ideally is a high molecular-weight polymer that is soluble or dispersible in the proper solvent. Coating additives such as plasticizers, colorants, opacifiers and antisticking agents may be used to obtain specific properties or to facilitate the coating process. When a polymeric solution is applied (sprayed) onto substrates, the film coat is formed and adhered immediately upon drying.

Over the past 30 years, the growing awareness of safety, environmental and economical issues has markedly increased interest in aqueous-based coating systems in pharmaceutical industry instead of using organic-solvent-based systems. Today a variety of aqueous synthetic cellulose derivatives are available for film coatings. Hydroxypropyl methylcellulose (HPMC), hydroxypropyl cellulose (HPC) and sodium carboxymethyl cellulose (NaCMC) are often used as conventional water soluble masking or protective coatings for tablets and pellets. Other cellulose derivatives that are insoluble at low pH but freely soluble above pH 5-6 can be used for enteric film coating (i.e. ATI is released in the intestinal tract). These aqueous enteric derivatives include e.g. cellulose acetate phthalate (CAP), hydroxypropyl methylcellulose phthalate (HPMCP), and hydroxypropyl methylcellulose acetate succinate (HPMCAS). Ethyl cellulose (EC) can be used for prolonged release coatings in aqueous dispersions. With regard to chemical nature, also acrylates, vinyls and glycols can be used for aqueous film coating. All these coating materials have their special advantages and limitations related to performance of the final drug product.

In the future the number of various peptide and protein type ATIs is expected to be rapidly increased after passing the pre-clinical phase I, and much concern is focused on compatibility of ATIs of this type and the pharmaceutical excipients available today (including film coating agents). Whey proteins are common by-products of dairy and milk industry today and they are by chemical structure very close to those new peptide type drugs. They are also produced in large quantities worldwide. Whey proteins comprise β-lactoglobulin (β-Lg), α-lactalbumin (α-La), bovine serum albumin (BSA) and some immunoglobulins (Dybing and Smith 1991). β-lactoglobulin is the major component of whey proteins (approx. 50-60% of the protein). It is a globular molecule with known secondary structure (15% α-helix, 50% β-sheet and 15 to 20% reverse turn). At physiological pH it exists as dimers. Each monomer comprises 162 amino acids and contains two intrachain disulfide bonds and one free cysteine (Wong et al. 1996). No risk of BSE is recognized related to the present proteins of milk origin unlike is the case on for example commonly used gelatine.

Native and modified whey proteins as film coating materials for solid pharmaceutical dosage forms and their applicability in pharmaceutical film coating processes have not been described in the art. Applications of whey proteins as an edible film material for food and nutrients are known in the art (Gennadios et al. 1993, McHugh and Krochta 1994 a,b, Kim and Morr 1996, Anker et al. 2002). Generally whey proteins are heated to denature proteins and expose the internal sulfhydryl groups to allow formation of inter-molecular disulfide bonds which affect the film structure. The combination of resulting intermolecular disulfide bonds and intermolecular interactions between protein chains based on hydrogen bonding, hydro-phobic interactions and electrostatic forces produce brittle films.

Conventional native whey proteins are considered as good barriers against oxygen at low and intermediate relative humidity and have good mechanical properties, but their barrier against water vapor can be questioned due to their hydrophilic character (Anker at al. 2002). Gennadios and co-workers (1993) studied effects of temperature on oxygen permeability of edible protein-based films. McHugh and Krochta (1994 a,b) utilized an approach to evaluate oxygen permeability and mechanical properties of edible whey protein films plasticized with glycerol and sorbitol. The oxygen permeability and tensile properties of the films were found to be even more favorable compared with those of synthetic film materials. More recently, Kim and Morr (1996) have reported the encapsulation properties of several food proteins and the physical and chemical properties of the respective microcapsules.

For characterization of film forming and coating capacity of new polymers and also film properties, the evaluation of free films has proved a useful technique. Free films can be prepared by using either casting or spraying techniques. The latter one is generally considered to be more realistic representation of the film in its end-use state. Film coating quality and properties, however, should be finally tested with film-coated drug products manufactured by perforated side-vented pan or air-suspension coating methods.

### REFERENCES CITED [REFERENCED BY]

Anker, M.; Berntsen, J.; Hermanson, A.-M. and Stading, M., Improved water vapor barrier of whey protein films by addition of an acetylated monoglyceride. Innovative Food Sci. & Emerging Technologies 3, 81-92 (2002)
Aydt, T. P., Weller, C. L. and Testin, R. F. Mechanical and barrier properties of edible corn and wheat protein films. Am. Soc. Agric. Eng. 34, 207-211 (1991)
Dybing, S. T., and Smith, D. E, Relation of chemistry and processing procedures to whey protein functionality: A review. Cult. Dairy Prod. J. 57, 377-391 (1991)
Friedman, M. Improvement in the safety of foods by SH-containing amino acids and peptides. A review. J. Agric. Food Chem., 42, 3-20. (1994)
Gennadios A., Weller C. L. and Testin R. F., Temperature effect on oxygen permeability of edible protein-based films. J. Food Sci., 58, 212-214, 219 (1993)
Gontard, N., Duchez, C., Cuq, J-L. and Guilbert, S. Edible composite films of wheat gluten and lipids: water vapour permeability and other physical properties. Int. J. Food Sci and Technol. 29, 39-50 (1994)
Kim Y. D. and Morr C. V., Microencapsulation properties of gum arabic and several food proteins: Spray-dried orange oil emulsion particles. J. Agric. Food Chem., 44, 1314-1320 (1996)
Mate, J.; Frankel, E. N.; Krochta J. M., Whey protein isolate edible coatings: Effect on the randicity process of dry roasted peanuts. J. Agric. Food Chem., 44, 1736-1740 (1996)
McHugh T. H. and Krochta J. M., Milk-protein-based edible films and coatings. Food Technology, 48, 97-103 (1994)
McHugh T. H. and Krochta J. M., Sorbitol-vs glycerol-plasticized whey protein edible films: Integrated oxygen permeability and tensile property evaluation. J. Agric. Food Chem., 42, 841-845 (1994).
Shimada, K. and Cheftel, J. C., Texture characteristics, protein solubility, and sulfhydryl group/disulfide bond contents of heat-induced gels of whey protein isolate. J. Agric. Food Chem. 36, 1018-1025 (1988)
Stevenson E. M.; Law, J. R.; Leaver, J. Heat-induced aggregation of whey proteins is enhanced by addition of thiolated β-casein. J. Agric. Food Chem., 44:2825-2828 (1995)
Wong, D. W. S., Camirand, W. M. and Pavlath, A. E., Structures and functionalities of milk proteins Crit. Rev. Food Sci Nutr. 36, 807-844 (1996)

### BRIEF DESCRIPTION OF THE INVENTION

The present invention provides a method for preparing a protein-based film comprising a protein network formed by disulfide bonds between the proteins comprising forming a solution of pH 7 or below containing modified protein, which protein is modified by cleaving at least one disulfide bond originally present in said protein in sulfitolysis by sulfonation to obtain free sulfhydryl groups, to cause an interchange reaction by said free sulfhydryl groups forming said disulfide bonds between the proteins, and forming said solution into said protein-based film. The forming into film may be promoted by drying, heating or by any other suitable method.

The solution may contain also unmodified protein. The unmodified protein may comprise any type of protein or multiple proteins. Examples of such proteins suitable for use in the method of the invention are whey or soy proteins. The unmodified protein is generally used as the main support for creating the protein network and it may be present in larger amounts than the modified protein. However, if only modified protein is used for preparing the film, it may contain also an amount of unmodified protein depending on the degree of modification.

The modified protein may contain any protein wherein at least one disulfide bond originally present in said protein has been cleaved in sulfitolysis to obtain free sulfhydryl groups, which are able to react with other proteins in an interchange reaction. Examples of such proteins suitable for use in the method of the invention are activated soluble whey proteins described below.

The present invention provides also a solution useful for preparing a protein-based film having pH 7 or below and containing modified protein, which protein is modified by cleaving at least one disulfide bond originally present in said protein in sulfitolysis by sulfonation to obtain free sulfhydryl groups, which are able to cause an interchange reaction to form disulfide bonds between the proteins. The solution may contain also unmodified protein.

The present invention provides also a protein-based film comprising a protein network which is formed by treatment with modified protein in a solution having pH 7 or below, which protein is modified by cleaving at least one disulfide bond originally present in said protein in sulfitolysis by sulfonation to obtain free sulfhydryl groups, whereupon an interchange reaction by said free sulfhydryl groups has occurred forming said disulfide bonds between the proteins. The above-mentioned solution may be used to prepare said film.

Generally the film formation is carried out at acidic or neutral pH since at alkaline pH the sulfonate derivatives will stay in the film and such film is generally not suitable for use as edible film. Also lysinoalanine is formed at alkaline conditions. For film formation suitable pH can be for example in the range of 4.5-7.0 and for emulsions in the range of 2-7. The most efficient pH for the interchange reaction is about pH 3.5, but the pH range used depends also on the application used.

The film may be formed on any suitable substance or substrate to coat it. Such substance may be a solid support onto which the film is formed, dried and removed later on for use as standalone film for other applications. A substance may also be a substance onto which the film is formed permanently or as non-removable, such as an edible substance to be coated with said film, for example a food product, pharmaceutical compound or a lipid or like. Generally the substance may be coated completely or partially depending of the purpose of application and use. In one embodiment lipids are coated with said film to form emulsions or microcapsules. One specific example of such coated lipids is an emulsion usable in a milk substitute such as baby's milk formula (i.e. infant formula).

In one embodiment said substance is a container, such as a disposable or non-disposable beaker, cup, plate or the like, wherein said film will improve the properties of the container, such as water impermeability. Said container may be made of any suitable material, edible or non-edible, such as carbohydrate, cardboard or the like.

In an embodiment the amount of free sulfhydryl groups in the total protein of the solution before the interchange reaction is 0.5-60 μmol/g protein. Preferred range for free SH groups is 30-50 μmol/g for most of the applications.

It is an object of the present invention to provide a novel method for preparing aqueous protein films without any long-term heating treatment in high temperatures. These films can be used to coat wide variety of different kinds of substances. Furthermore, it is still another object of the present invention to provide films that can be effectively modified by different treatments or by inclusion of adjuvants in order to modify the properties of the films for various applications. One additional goal will be also to obtain functional and health-improving final products. The proteins to be used in the method of the present invention are proteins which naturally contain at least one disulfide bond, such as whey proteins.

It is another object of the present invention to develop novel films and coatings, capsule shells, microcapsules and related, and emulsions to be used for various purposes in the fields of food technology, pharmacy, and agriculture. In one embodiment these films and coatings comprise activated soluble whey protein (ASWP). Within the field of pharmacy, an aqueous ASWP coating formulation and process that would have good film coating ability and that would provide the film coatings with a low water vapor (WVT) and oxygen transmission and with satisfactory mechanical strength properties, are described. It is still another object of the present invention to obtain aqueous film coating formulations that can be successfully applied onto solid pharmaceutical dosage forms (e.g. granules, pellets and tablets) and food in the established industrial coating processes, and that the respective films are stable during storage and do not dissolve in water. Furthermore, it is still another object of the present invention to develop new capsule shells, such as ASWP-based, that could replace the gelatine ones in capsulation of different kinds of solid and semi-solid substrates.

The present invention is based on the surprising discovery that when a solution containing proteins is treated with modified protein which is modified by cleaving at least one disulfide bond originally present in said protein to obtain free sulfhydryl groups and the free sulfhydryl groups will cause an interchange reaction wherein disulfide bonds will be formed between proteins and a protein-based film structure will be formed. According to one embodiment of the invention this modified protein is an activated soluble whey protein (ASWP) fraction obtained from a protein isolation process, such as described in FI 107116.

In the modification reaction the disulfide bonds (SS) between the amino acids chains of the proteins are cleaved and free sulfhydryl groups (SH) are formed. This kind of protein is called herein a ‘modified protein’ or an ‘activated protein’ as both terms may be used interchangeably. The modification reaction can be carried out in several ways but most of them are not suitable for applications concerning food or pharmaceutical products i.e. for edible products. For example one such method for increasing the amount of free SH groups is described in Stevenson et al. (J. Agric. Food Chem. 1995, 44:2825-2828) wherein a synthetic protein-containing free SH groups and several SS bonds is created. Thus, according to the present invention it is practical to use only such proteins which originally, i.e. before the modification, contain at least one disulfide bond.

In a preferred embodiment the protein is modified by treating it with sulfite ion forming agent to sulfonate the protein in sulfitolysis. Preferred sulfite ion forming agents are soluble food grade sulfites, such as alkali metal or earth alkali metal sulfites, hydrogen sulfites or metabisulfites or combinations thereof. Preferred sulfite is sodium sulfate. Preferably no separate oxidizing agent or catalyst is added. This method for sulfonating proteins is described in FI101514 and FI107116 wherein the modification reaction is carried out in order to isolate whey proteins by changing its structure. No specific further applications or methods thereof for modified proteins are described in these documents. In the isolation process part of the modified whey protein is precipitated at low pH and part of it will remain soluble. These fractions can be further used in the method of the present invention.

An important factor affecting the degree of modification of the protein is the amount of sulfite per amount of protein used. According to current practice the amount of sulfite as sodium metabisulfite is about 0.01-0.06% (w/v), when the amount of protein in the solution is 10-11% (w/v), the temperature 50-60° C. and the pH 6-7. Surprisingly the amount of sulfite required was found to be substantially lower than described in FI101514 or FI107116.

Reaction time during which the sulfonation reaction/sulfitolysis occurred was 30 min. Thereafter pH was adjusted to 2-3 to liberate SO₂ from sulfonate derivatives of protein and residual sulfite. The SO₂ was blown with air out of the reactor and was reused as sulfite. Later, pH was adjusted to 4-6 and modified protein concentrate was washed with water and ultrafiltered to the concentration needed e.g. 10-20% on protein content.

For fractionation the modified whey protein concentration was microfiltered to separate the fractions, precipitate and soluble fraction. Both fractions were washed and concentrated by ultrafiltration to 10-50% (w/v) according to the use.

The proteins useful in the method of the present invention include all non-synthetic proteins containing at least one disulfide bond as it will be cleaved in the modification step. The preferred proteins are whey proteins, such as ASWP described herein. The whey proteins and fractions thereof described herein and in the examples below are used as examples to enlighten the present invention. Other types of proteins can be used as well as long as they can be modified as described herein. One useful type of protein is soy protein which is abundantly used for example in food industry and which contains SS bonds in its native form.

ASWP can be proposed and introduced as a starting material for pharmaceutical and food film coatings and for encapsulation of solid and semi-solid substrates. The present ASWP comprises substantially pure β-lactoglobulin, which is activated differently as earlier (McHugh and Krochta 1994) and in which the number of SH groups has been increased without any heating treatments. It is evident that this new activated soluble whey protein fraction provides much advantages associated with protein film formation and final film properties compared with those conventional native whey proteins applied as an edible film material for food and nutrients. The present protein innovation makes it also possible to use spraying technique for film formation and makes it possible to avoid the well-known limitations related to application of gelatin as a raw material for encapsulation. Furthermore, spray-dried AWSP powder can be easily transferred to a film coating manufacturing plant and subsequently, dissolved into the aqueous coating solution just prior to film coating operation. This provides great advantages for e.g. pharmaceutical or food industry as regards with transportation, storage, raw material stability and final applicability points of view.

In one embodiment of the invention, it is discovered that aqueous protein films can be prepared from modified protein, preferably from activated soluble whey protein fraction, by inclusion of an external plasticizer, e.g. glycerol, sorbitol or polyethylene glycol (PEG) (or mixtures thereof). After preparing the solution, it can be spread onto the mold and allowed to dry for example overnight in the ventilated room conditions (25° C./40-50% RH). The dried film is then ready to be peeled. Furthermore, it is observed that ASWP as a film former can be combined with e.g. native whey proteins or other, preferably related, protein concentrate (75% or more) or isolate, in the interchange reaction (FIG. 1), and thus modify the physicochemical and pharmaceutical properties of the films. Following the interchange reaction, proteins will form a three-dimensional network, which plays an essential role in the formation of gel and film structures. SH groups will prevent initiation of harmful side reactions and formation of side products including lysinoalanine and compounds that are formed at the beginning of a Maillard reaction (i.e. Amadori compound) (FIG. 2).

In the interchange reaction, the number of SH groups will not decrease. The number of SH groups can be diminished by oxidizing them with oxygen of the air to form disulfide groups, i.e. 2×SH+½×O₂→S—S+H₂O, which will strengthen the structure of the gel or film. Depending on the purpose, it is beneficial to let a suitable amount of SH groups remain, since SH groups act as antioxidants, neutralize toxic compounds of vegetative or microbial origin and inactivate e.g. acryl amide.

In addition, beneficial effects of SH groups are also derived from metal chelation, whereby sulfur ligands sequester peroxidant Cu²⁺ and ^{Fe2+} and potentially toxic As³⁺, Cd^{2+,} Co^{3+,} Hg^{2+,} Pb²⁺ and Se²⁺ in both inorganic and organic compounds.

SH groups may inhibit 1) the formation of Amadori compound, which is formed at the beginning of the Maillard reaction and 2) the formation of lysinoalanine, which in turn forms during alkali treatment of protein especially by heating. (Friedman 1994).

A product prepared with the method of the present invention can be distinguished from a product prepared with traditional heating method based on the physical properties of the products. For example when comparing said products the average amount of SH groups present in modified and fractionated whey proteins is significantly higher than in traditional products, about 2-4 SH groups per protein molecule vs. less than 1 SH group per protein molecule, respectively. These properties can be studied with methods well known in the art, such as liquid chromatography. Also, the amount of side products, such as Amadori compound or lysinoalanine, in the product according to the invention is significantly lower than in traditional products. These compounds may also be determined using methods known in the art, for example with Ellmann reagent or liquid chromatography.

By inclusion of the certain adjuvants, the physicochemical and pharmaceutical properties of the gels and films can be modified. With lipophilic compounds, such as soya oil or other oils, and by emulsifying these compounds into the protein structure, one can decrease the permeability of the films to moisture and water vapor and strengthen the structure of the protein. By inclusion of carbohydrate, such as maltodextrin, one can slow down the effects of proteolytic enzymes and increase the mechanical strength of the structure of the protein.

Also other types of additives can be included for example to enhance the stability of the films. Such additives include antiadhesive agents, such as TiO₂, antimicrobial agents such as E code marked natamycin (E 235) and preservative agents such as sorbic acid (E 200) and its salts, benzoic acid (210) and its salts, parabeens (E 214-219), lactic acid (E 270) and its salts, propionic acid (E 280) and its salts and the like.

The film coatings of the present invention will have a lot of applications in the fields of food technology, pharmacy, and agriculture. The films according to the present invention that can be modified with respect to their properties and they can be applied (1) as coatings for food products to protect them against mechanical stresses, drying, oxidizing or harmful external substances, (2) as coatings for tablets, granules and related pharmaceutical solid dosage forms, (3) as capsule shells for pharmaceutical or related purposes, (4) as basic raw materials for preparing micro-capsules, nanocapsules, emulsions or related, and (5) as coatings for several kinds of containers, such as disposable beakers, cups, plates and the like.

The following table shows a comparison of the composition and functional properties of the modified whey protein according to the invention and intact whey protein.

| | Modified | Intact |
|---|---|---|
| Property | protein | protein |
| Modification by sulfitolysis | + | − |
| Degree of modification | 15-30% | 0% |
| Free SH groups/protein molecule | 2-4 | <1 |
| Interchange reaction SH—/S—S in | + | + |
| formation of net structure | | |
| Conditions for interchange | | |
| temperature | 70-85° C. | 85-95° C. |
| exposure time | less than | 15-30 min |
| | 15 min | |
| Rate of interchange | Quick | Slow |
| Formation of emulsion | +++ | + |
| Formation of gel | +++ | + |
| Digestibility/hydrolysability | +++ | + |
| of protein | | |

### BRIEF DESCRIPTION OF THE FIGURES

FIG. 1. Interchange reaction and interchange modification

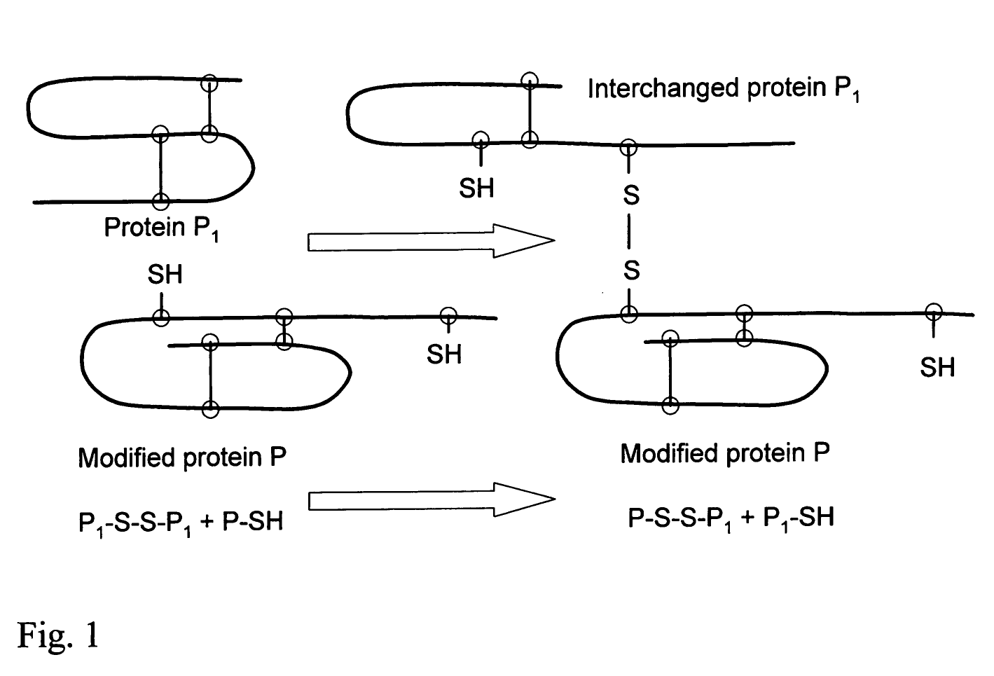

FIG. 2. Formation of Amadori compound

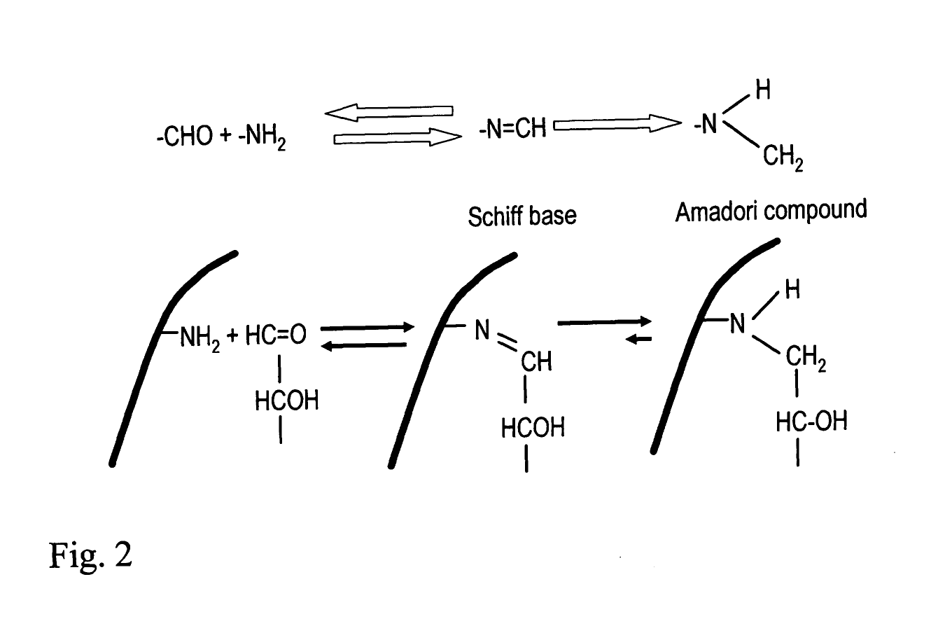

FIG. 3. Scanning electron micrograph (SEM) of encapsulated rape seed oil

FIGS. 4A-B. Scanning electron micrographs on the surfaces of aged free films prepared from aqueous ASWP solutions (Film: ASWP 3%, Glycerol 1%; Drying: 70° C. 10 min; Storage: 1 month, 25° C./60% R.H.). The magnifications are A) ×500 and B) ×1000.

FIGS. 5A-D. Scanning electron micrographs on the surfaces of aged free films prepared from aqueous ASWP solutions (Film: ASWP 4%, Glycerol 2%; Drying: 70° C. 10 min; Storage: 1 month, 25° C./60% R.H.). The magnifications are A) ×100, B) ×500, C) ×800 and D) ×1000.

FIGS. 6A-B. Scanning electron micrographs on the surfaces of aged free films prepared from aqueous ASWP solutions (Film: ASWP 3%, Glycerol 2%; Drying: 70° C. 20 min; Storage: 1 month, 25° C./60% R.H.). The magnifications are A) ×500 and B) ×5000.

FIGS. 7A-C. Scanning electron micrographs on the surfaces of aged free films prepared from aqueous ASWP solutions (Film: ASWP 4%, Glycerol 1%; Drying: 70° C. 20 min; Storage: 1 month, 25° C./60% R.H.). The magnifications are A) ×100, B) ×500 and C) ×1000.

FIGS. 8A-C. Scanning electron micrographs on the surfaces of aged free films prepared from aqueous ASWP solutions (Film: ASWP 3%, Glycerol 2%; Drying: 80° C. 10 min; Storage: 1 month, 25° C./60% R.H.). The magnifications are A) ×100, B) ×500 and C) ×1000.

FIGS. 9A-B. Scanning electron micrographs on the surfaces of aged free films prepared from aqueous ASWP solutions (Film: ASWP 4%, Glycerol 1%; Drying: 80° C. 10 min; Storage: 1 month, 25° C./60% R.H.). The magnifications are A) ×500 and B) ×1000.

FIGS. 10A-C. Scanning electron micrographs on the surfaces of aged free films prepared from aqueous ASWP solutions (Film: ASWP 3%, Glycerol 1%; Drying: 80° C. 20 min; Storage: 1 month, 25° C./60% R.H.). The magnifications are A) ×100, B) ×500 and C) ×1000.

FIGS. 11A-C. Scanning electron micrographs on the surfaces of aged free films prepared from aqueous ASWP solutions (Film: ASWP 4%, Glycerol 2%; Drying: 80° C. 20 min; Storage: 1 month, 25° C./60% R.H.). The magnifications are A) ×100, B) ×500 and C) ×1000.

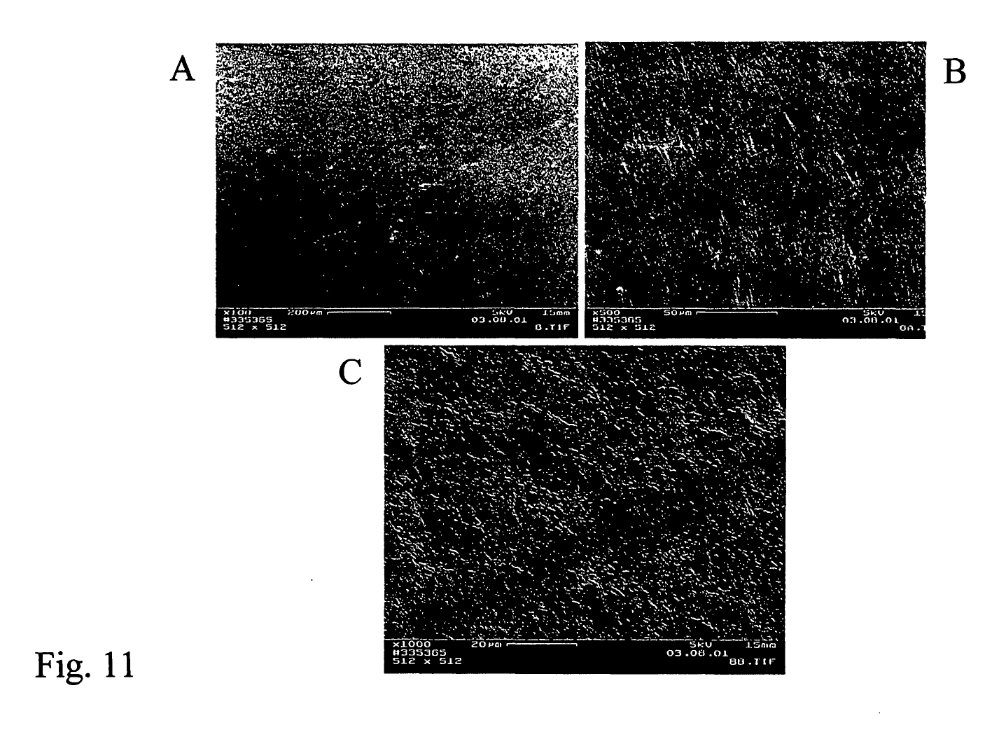

FIG. 12. Atomic force micrographs (AFM) on the surfaces of aqueous free films of ASWPs. Medium treatment seems to give smaller droplets (as shown in figure B).

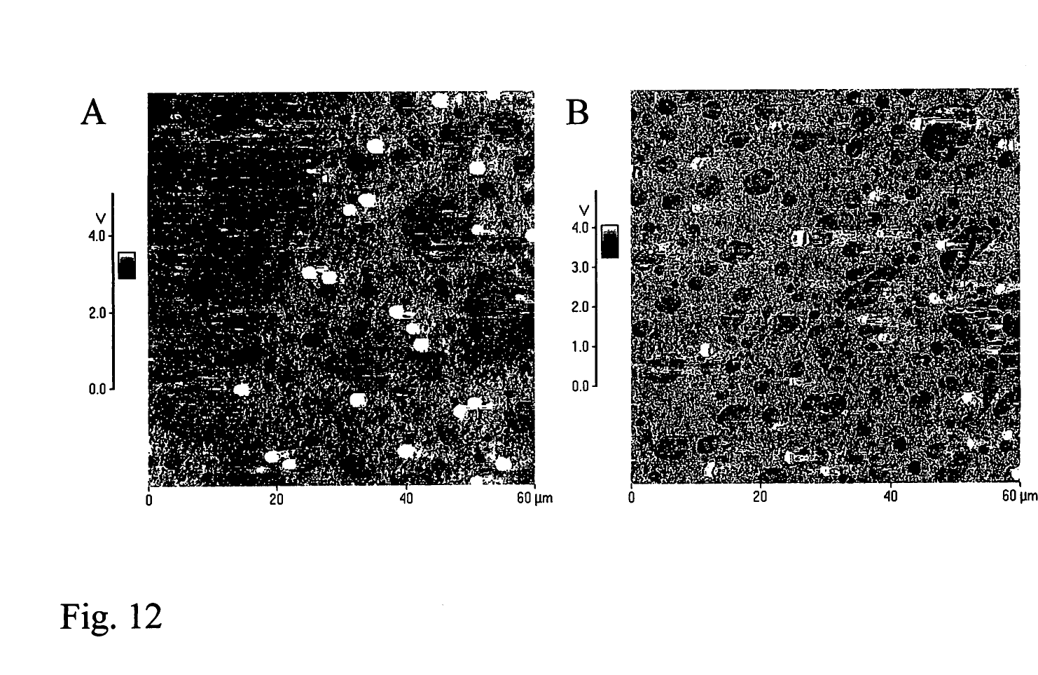

FIG. 13. Scanning electron micrographs on the unpigmented ASWP films (composition 1 as presented in Table 21). The magnifications are A) ×500, B) ×10000 and C) ×675.

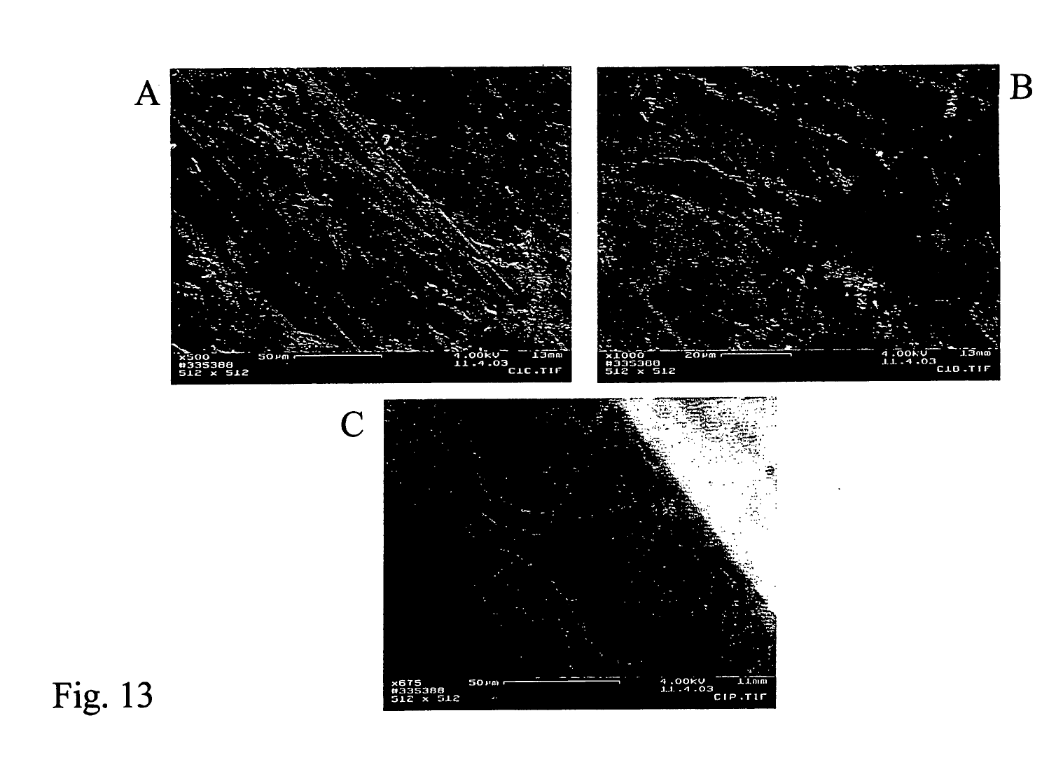

FIG. 14. Scanning electron micrographs on the pigmented ASWP films (composition 3 as presented in Table 21). The magnifications are A) ×500, B) ×1000 and C) ×550.

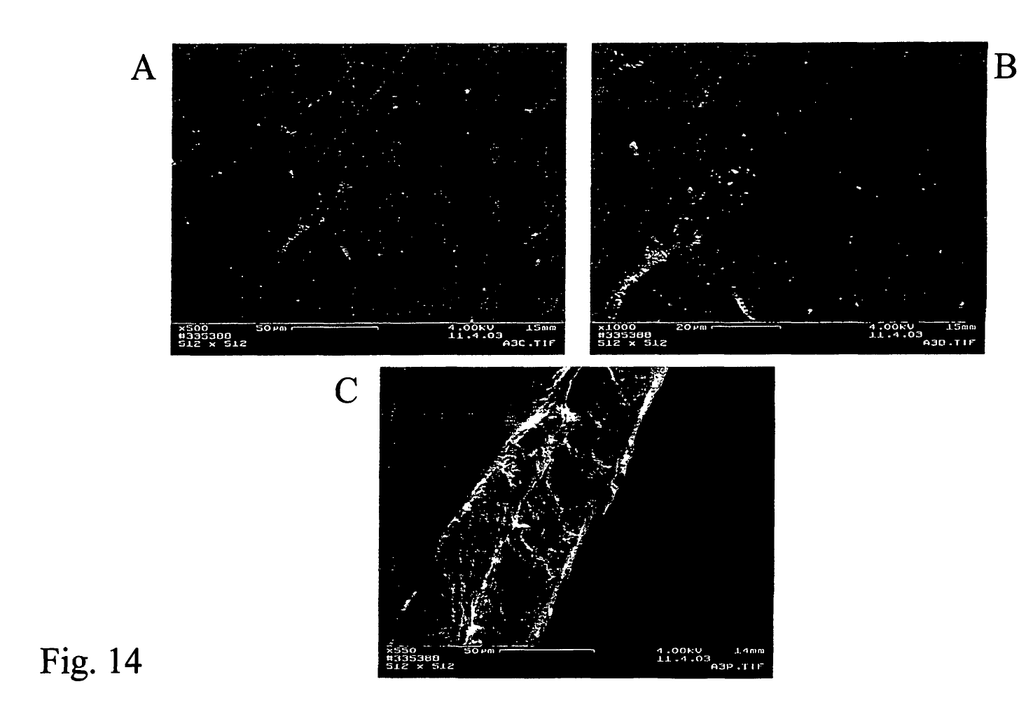

FIG. 15. Scanning electron micrographs on maltodextrin containing ASWP films (ASWP/P67 7.5%, maltodextrin DE9 5%, glycerol 4%, sorbitol 1%; 70° C./1 h). The magnifications are A) ×500, B) ×1000 and C) ×5500.

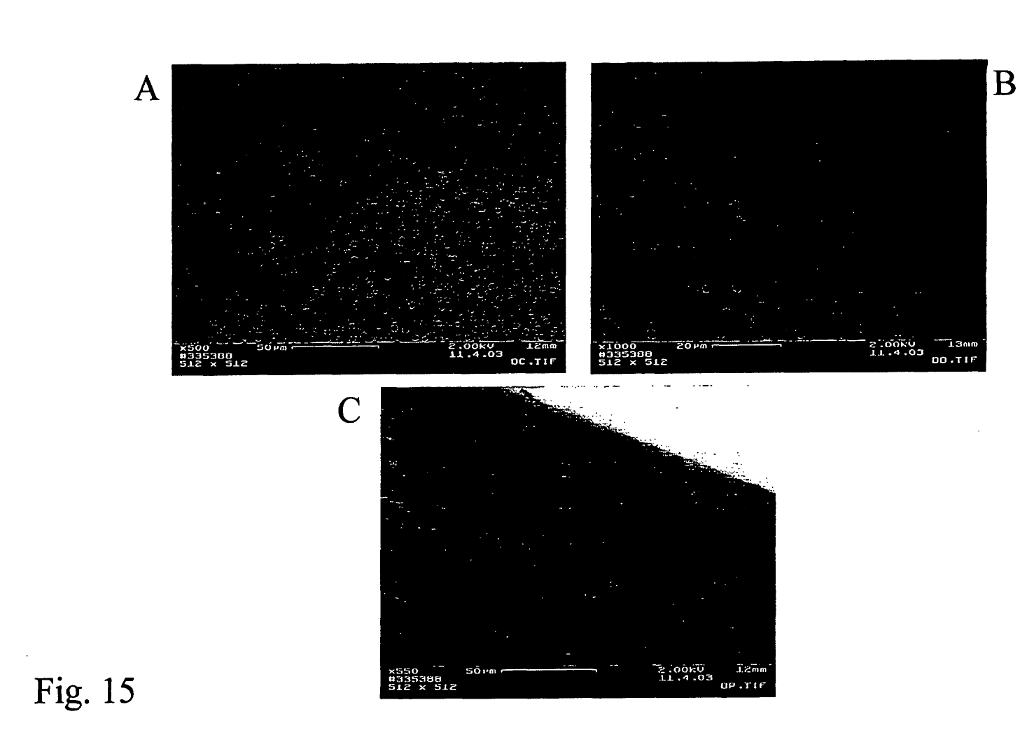

FIG. 16A-D. X-ray diffraction patterns of fresh and aged unpigmented films of AWPS (compositions 1 and 2 as presented in Table 21). The film samples are stored for 0-6 months at ambient room conditions (25° C./60% RH) and at stressed conditions (50° C.). Key: Film composition 1 stored at 25° C./60% RH and at 50° C. (upper two figs C, respectively); Film composition 2 stored at 25° C./60% RH and at 50° C. (lower two figs D, respectively). Y-axes represent intensity and x-axes two-theta (degrees).

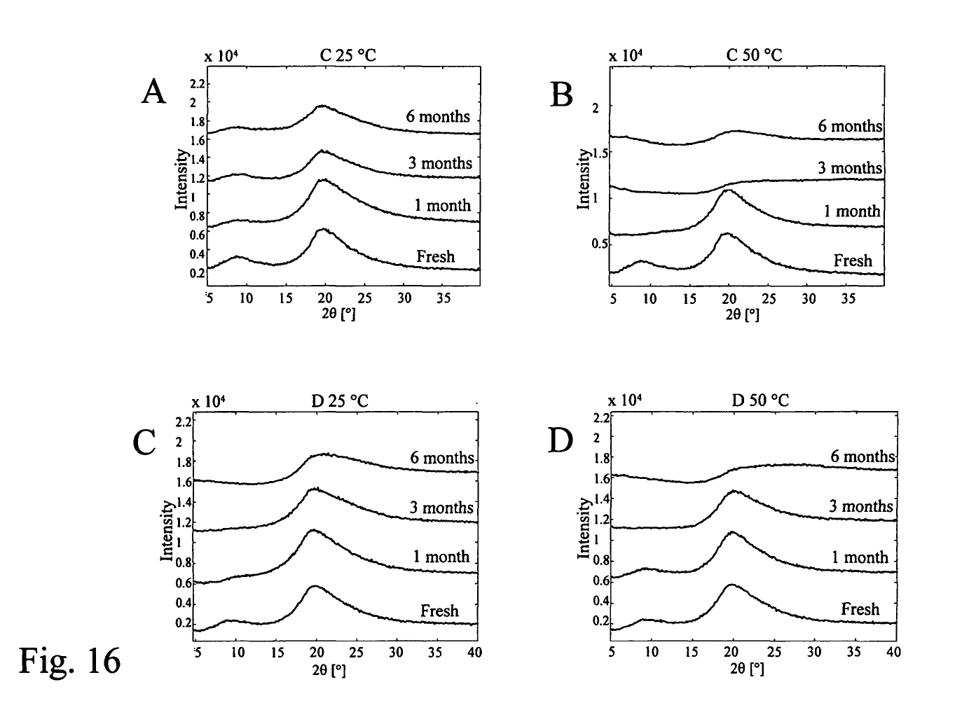

FIG. 17A-D. X-ray diffraction patterns of fresh and aged pigmented films of AWPS (compositions 3 and 4 as presented in Table 21). The film samples are stored for 0-6 months at ambient room conditions (25° C./60% RH) and at stressed conditions (50° C.). Key: Film composition 3 stored at 25° C./60% RH and at 50° C. (upper two figs A, respectively); Film composition 4 stored at 25° C./60% RH and at 50° C. (lower two figs B, respectively). Y-axes represent intensity and x-axes two-theta (degrees).

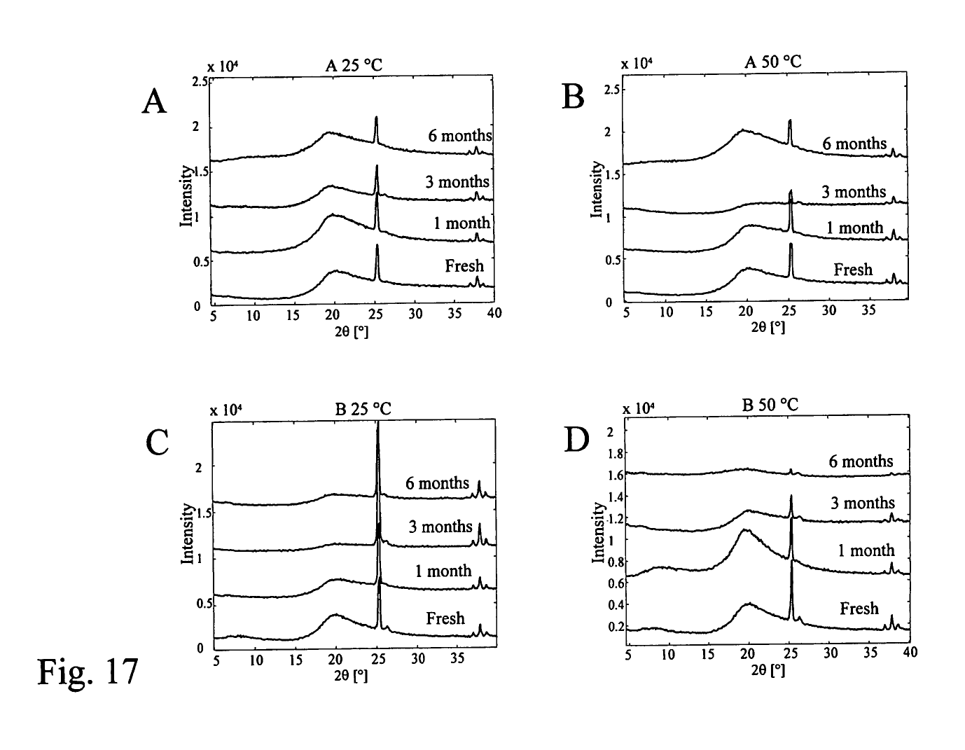

### DETAILED DESCRIPTION OF THE INVENTION

Films and Coatings

According to one embodiment of the present invention, the soluble whey protein fraction from whey protein isolation process (based on FI 107116) is used as an aqueous film forming agent for the edible films. The protein comprises activated pure P-lactoglobulin (over 95% w/w from the dry material) in which the number of SH groups has been increased (up to 40 μmol/g) without any heating treatments. Protein films are formed at the ASWP concentrations of 3-10% (w/v). As plasticizers, for example glycerol, sorbitol, polyethylene glycol (PEG) or mixtures thereof can be used 1-6% (w/v) calculated from the total solution. The pH of film forming solutions can be in the range of 4.5-7.0. The films are formed without any heating treatment, but heating (e.g. at 70-80° C. for 10-20 minutes) may be used to improve e.g. the mechanical strength and pH resistance of the films. The times and temperatures required in the heat treatment are lower than generally used in the traditional methods. The ASWP films are clear and almost transparent.

In another embodiment of the present invention the soluble whey protein as a film former can be replaced by the activated interchanged protein, which contains 15-30% soluble fraction and the rest of the protein (70-85%) comprises microfiltrated whey protein concentrate or isolate. Interchange reaction may require heating, for example at 70-80° C. for 10-20 minutes. The obtained protein films are almost clear and transparent.

In another embodiment of the present invention the mechanical strength and resistance (to for example pepsine hydrolysis) can be increased by adding carbohydrates, such as maltodextrins, in the composition of the present type protein films. This inclusion may require heating, for example at 70-80° C. for 10-20 minutes. The obtained protein films are almost clear and transparent.

The physicochemical properties of the protein films can be modified by inclusion of adjuvants. In one embodiment of the present invention the application of lipophilic compounds (e.g. inclusion of stearates at a concentration of about 1-2% and subsequently homogenizing at 80° C.) will improve the resistance of the films to moisture. In still another embodiment of the present invention the inclusion of a pigment dye, such as titanium dioxide, for example at a concentration of 0.5-1.5% will provide an effective protection from the UV light and related radiation.

As the protein solution is prepared, the temperature and pH of the solution are adjusted to proper level with respect to the subsequent use. The protein solution can be applied either as a liquid form or the solution can be also dried to a powder form by spray drying (or related method). The present proteins as a solid powder form provide great advantages since the powder can be easily stored for later use and redissolved to proper concentration just prior to its use in coating or related processes. For film preparation, solutions with total protein concentration of 5-14% (w/w) are preferred and the present solutions can be applied also for film coating of food and pharmaceuticals (e.g. tablets, capsules, granules, pellets and microcapsules. For preparing capsule shells, the protein solution should be more viscous and the concentration of total protein in the solution may be 30-50% (w/w).

For preparing the films, a fixed amount of protein solution is gently spread in the mold, and the film is allowed to dry at a room temperature (21-23° C./40-50% RH) for 18-20 hours. Homogenous films with a fixed thickness will be obtained.

For preparing edible films for food products, the protein solution can be applied by gently brushing, spreading, dipping or spraying. The film forming can be promoted by blowing warm air simultaneously to dry the surface of the film. Free SH groups are oxidized to SS groups and subsequently very firm and mechanically strong film is formed.

In film coating of pharmaceuticals containing therapeutically active agent (e.g. tablets, capsules, granules, pellets or microcapsules), the protein solution is sprayed onto the solid substrates (cores) by using a suitable spraying method and the liquid is evaporated simultaneously by heating the coating chamber. Any known pan, drum or air-suspension coating techniques and any modification of them can be applied. These techniques are well known in the art. The final film coat is homogeneous, firm and mechanically strong.

Capsule Shells

In another embodiment of the present invention protein-based capsule shells (that are alternative for gelatin capsules) are prepared by dipping a rod into the protein solution. Subsequently the protein-covered rod may be dried in warm air. Both the top and bottom of the capsule shell can be prepared by the present dipping method. After the filling procedure, the top and bottom parts of the capsule shell are combined and locked. This technique is known in the art for preparing gelatin-based capsule shells and it can be easily applied to the method of the present invention.

Emulsions and Microcapsule

A surprising discovery in the present invention is that modified proteins, such as ASWPs based on the FI 107116, both modified whey protein and precipitate fraction, can be applied in preparing emulsions and that emulsion prepared for example from the soluble fraction can be subsequently microencapsulated.

In still another embodiment of the present invention a method for emulsifying lipids/oils, lipophilic compounds and particles with proteins, such as ASWP or soluble whey protein fraction, is presented. Following this procedure, the proteins contain free SH groups. ASWP and whey protein fractions form alone or with native whey proteins or other suitable native proteins an emulsifying protein layer around the lipid droplet. The protein layer is formed as a result of three dimensional network that is created by SH groups which cleave the disulfide (SS) bonds and form the new ones with SH groups released during heating (e.g. during pasteurizing treatment). Emulsifying protein layer is formed generally at pH 2-8. The present emulsion can be microencapsulated e.g. by means of freeze drying or spray drying.

By emulsifying with proper emulsifiers, as with ASWP, one can greatly increase the physicochemical stability of lipids, oils, and lipophilic compounds (e.g. aromatic agents and spices) in food products and in aqueous medium. The release of for example lipophilic substances and volatile compounds of spices can be controlled.

In another embodiment microcapsules are prepared by spray drying the emulsions of the present invention. Microcapsules as solids are stable for a longer period of time than e.g. emulsions and provide better protection for the encapsulated substrates against external physicochemical stresses. The protection is dependent on the structure and thickness of the protein film covering the microcapsules. Microencapsulation is applied for protection of the substrates for example against oxygen, UV light and harmful compounds. On the other hand, microencapsulation is a useful technique in controlling the release rate or site of the (active) substances.

Another important application of the present invention is the preparation of baby's milk formula (mother's milk substitute) of precipitate fraction as an ingredient and emulsifier. Precipitate fraction contains substantially all the α-lactalbumin of whey protein. It is important because α-lactalbumin is the only whey protein of mother's milk. Precipitate fraction functions also as an emulsifier of oil, e.g. rape seed oil. No other emulsifier is needed any more.

### EXAMPLE 1

Method of Preparing ASWP Films

ASWP (i.e. activated soluble whey protein) films were prepared from the fraction obtained from a protein isolation process, such as described in FI 107116. The present ASWP comprises activated pure β-lactoglobulin in which the number of free SH groups (35-45 μmol/g in the protein) has been increased without any heating treatments.

Aqueous solution of ASWP comprising protein 4% (w/w) and glycerol 2% (w/w) was prepared. The pH of the solution was adjusted to pH 7.0 by using 1 M NaOH solution. The solution was stirred well and poured carefully (20 ml) into the Petri dishes (85 mm in diameter and made of polystyrene) for preparing the free films. The free films were allowed to dry at the horizontal level at 22° C./RH 45% for at least 22 hours. After drying the films were carefully peeled. They were transparent and elastic.

### EXAMPLE 2

Effect of Heating on the Formation and Properties of ASWP Films

Aqueous solutions of ASWP comprising protein 3% and 4% (w/w) and glycerol 1% and 2% (w/w) as a plasticizer were prepared. The following heating treatments were used (tested) for the solutions: 70° C./10 min; 70° C./20 min; 80° C./10 min; 80° C./20 min (Table 1).

TABLE 1
Compositions for the ASWP solutions
used in the heating experiments.

| | Composition (% w/w) | | | | | | | |
|---|---|---|---|---|---|---|---|---|
| Component | 1 | 2 | 3 | 4 | 5 | 6 | 7 | 8 |
| ASWP | 3 | 4 | 3 | 4 | 3 | 4 | 3 | 4 |
| Glycerol | 1 | 2 | 2 | 1 | 2 | 1 | 1 | 2 |

| | | | | |
|---|---|---|---|---|
| Heating | 70° C./ | 70° C./ | 80° C./ | 80° C./ |
| | 10 min | 20 min | 10 min | 20 min |

The ASWP solutions were stirred and the samples (compositions 1-8) were heated in the water bath. Following the heating for the predetermined period (10 min or 20 minutes), the samples were cooled at about room temperature (20-22° C.) and carefully pipetted to the Teflon molds (6.6 ml to each mold). The films obtained after drying were transparent and elastic. Adherence of the films was smaller if the heating temperature was kept high and the heating time was longer. The film-forming properties are shown in Example 19.

### EXAMPLE 3

Interchange Protein Free Films

Originally filtered whey protein concentrate and soluble whey protein fraction were mixed at a ratio of 70:30 to prepare 9% (w/w) aqueous solution. Glycerol and sorbitol were used as plasticizers at a level of 3% (w/w) and 1% (w/w), respectively. The pH of the solution was adjusted to pH 7.0 (1 M NaOH). The solution was heated for 30 min at 80° C., cooled down to room temperature (20-22° C.), and poured to the Teflon molds. The films were dried at a room temperature (21° C./45% RH) overnight. The films obtained were transparent and elastic.

### EXAMPLE 4

Interchange Protein Free Films

Whey protein isolate and soluble whey protein fraction were mixed at a ratio of 70:30 to prepare 10% (w/w) aqueous solution. Glycerol and sorbitol were used as plasticizers at a level of 5% (w/w) and 1% (w/w), respectively. The pH of the solution was adjusted to pH 7.0 (1 M NaOH). The solution was heated for 5 minutes at 80° C., cooled down to room temperature (20-22° C.), and poured to the Teflon molds. The films were dried fast at the temperature of 80° C. for one hour. The films obtained were transparent and elastic.

### EXAMPLE 5

Aqueous ASWP Film Coating Solutions

Aqueous solutions of ASWP comprised the protein (5% and 6% w/w) and the mixture of glycerol (1-3% w/w) and sorbitol (1-3% w/w) as a plasticizer. The pH of the solution was adjusted to pH 7.0 (1 M NaOH). Total 14 combinations of the film former and plasticizer were tested as shown in Tables 2 and 3.

TABLE 2
Film coating experiments (Part 1).

| | Composition (%) | | | |
|---|---|---|---|---|
| | | | | Coating |
| Exp. | ASWP | Glycerol | Sorbitol | solution |
| 1. (C) | 5 | 0 | 0 | Preheating |
| 2. (J) | 5 | 1 | 0 | Preheating |
| 3. (D) | 5 | 0 | 1 | Preheating |
| 4. (A) | 5 | 1 | 1 | Preheating |
| 5. (E) | 5 | 2 | 0 | Preheating |
| 6. (F) | 5 | 0 | 2 | Preheating |
| 7. (B) | 5 | 2 | 2 | Preheating |
| 8. (I) | 5 | 3 | 0 | Preheating |
| 9. (K) | 5 | 0 | 3 | Preheating |
| 10. (G) | 5 | 3 | 3 | Preheating |

TABLE 3
Film coating experiments (Part 2)

| | Composition (%) | | | |
|---|---|---|---|---|
| | | | | Coating |
| Exp. | ASWP | Glycerol | Sorbitol | solution |
| 1. | 5 | 1 | 1 | No preheating |
| 2. | 5 | 1 | 1 | Preheating |
| 3. | 6 | 1.2 | 1.2 | No preheating |
| 4. | 6 | 1.2 | 1.2 | Preheating |

Results of the respective film coating experiments are presented in Example 20.

### EXAMPLE 6

Water Impermeability

Whey protein isolate and soluble whey protein fraction were mixed at a ratio of 70:30 to prepare 10% (w/w) aqueous solution. Glycerol and sorbitol were used as plasticizers at a level of 5% (w/w) and 1% (w/w), respectively. The pH of the solution was adjusted to pH 7.0 (1 M NaOH). The solution was heated for 5 min at 80 ° C. in water bath, cooled down to room temperature (20-22° C.).

5 ml of the solution was pipetted onto the surface of a piece of cardboard and was spread with a ruler over the surface. The film was dried at room temperature (21° C./45% RH) overnight. The cardboard covering film was tested for impermeability of water by setting few drops of water on the surface of the film-covered cardboard and for comparison also on the surface of the uncovered cardboard. It took about 1.5 hours for the water drops to absorb through the film on the surface of the card-board and 15 minutes to absorb into the uncovered cardboard.

### EXAMPLE 7

Addition of Maltodextrin in the ASWP Films

The ASWP fraction was used to prepare 7.5% w/w aqueous solution containing also maltodextrin (degree of hydrolysis 9%) 5% w/w and glycerol 4% w/w and sorbitol 1% w/w as plasticizers. The pH of the solution was adjusted to pH 7.0 (1 M NaOH). The solutions were heated in the oven for 1 hour at 70° C. (A) and at 80° C. (B), and subsequently cooled down to the room temperature (20-22° C.) and poured into the Teflon molds. The free films were dried at the horizontal level at 21° C./RH 45% for 48 hours (A) and for 24 hours (B). After drying the films were peeled. They were transparent and elastic. Free films of A type were easily sticking but this character was not observed with the films of B type.

### EXAMPLE 8

Acid Resistance of the ASWP Films

Dissolution of the ASWP films was tested at pH 2.0 and pH 6.8. Original prefiltered whey protein concentrate and ASWP fraction were used at a ratio of 70:30 to prepare 9% w/w aqueous solution. Solution contained also maltodextrin 5% w/w (DE9) and glycerol 3% w/w and sorbitol 1% w/w as plasticizers. The pH of the solution was adjusted to pH 7.0 (IM NaOH). The solution was heated in the oven for 30 min at 85° C., cooled down to the room temperature (20-22° C.) and subsequently poured into the Teflon molds. The films were dried at the horizontal level at 21° C./RH 45% for 24 hours. After drying the films were peeled and tested. The present free films remained intact in 0.1 M HCl (pH 2) at 37° C. for 67 hours until they dissolved. The films remained also intact in 0.1 M HCl (pH 2) at 37° C. for 4 hours and after that in 0.1 M phosphate-citrate buffer solution (pH 6.8) at 37° C. for 4 hours.

### EXAMPLE 9

Enzymatic Treatment of the Films

Original prefiltered whey protein concentrate and ASWP fraction were used at a ratio of 70:30 to prepare 9% w/w aqueous solution. Solution contained also maltodextrin 5% w/w (DE9) and glycerol 3% w/w and sorbitol 1% w/w as plasticizers. The pH of the solution was adjusted to pH 7.0 (1M NaOH). The solution was heated in the oven for 30 min at 85° C., cooled down to the room temperature (20-22° C.) and subsequently poured into the Teflon molds. The films were dried at the horizontal level at 21° C./RH 45% for 24 hours. After drying the films were peeled and tested. The present free films were incubated in 0.1 M HCl (pH 2) containing 0.1% pepsin at 37° C. until they dissolved in 30-45 minutes.

### EXAMPLE 10

Emulsion and Microencapsulation

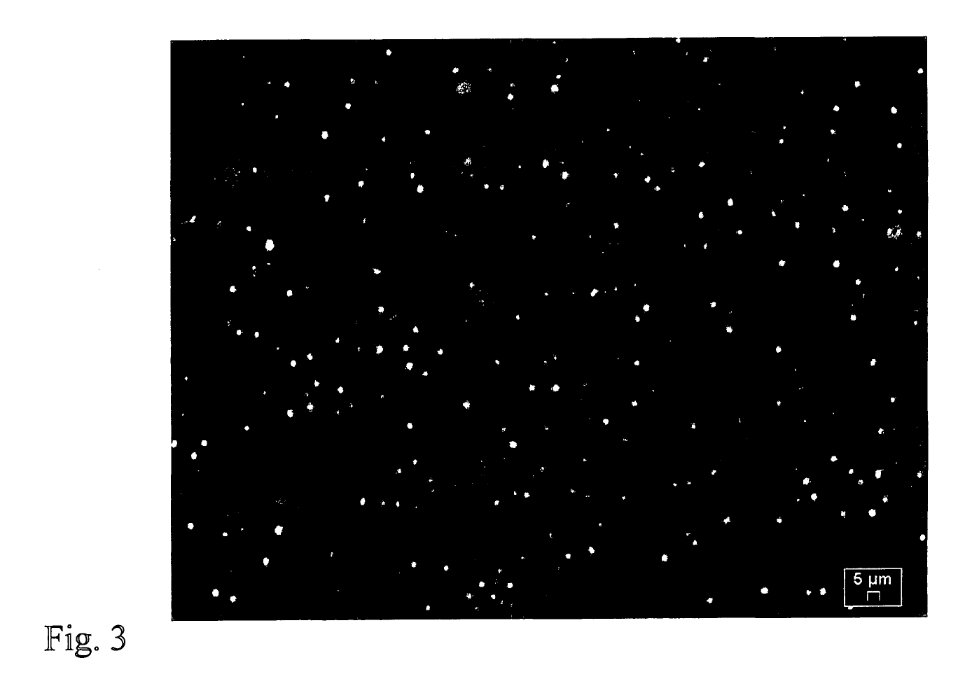

Original prefiltered whey protein concentrate and ASWP fraction were used at a ratio of 70:30 to prepare 5% w/w aqueous solution. Rape seed oil was added 13% w/w (calculated from the solution weight) and the pH of the mixture was adjusted to pH 6.5 (1 M NaOH). The mixture was heated in the water bath up to 60° C., then homogenized for 1-2 minutes with Ultra Turrax to get an emulsion and finally passed through the FT-9 homogenizer three times. The emulsion was pasteurized at 75-78° C. for 5 minutes and cooled down to the room temperature (20-22° C.). The final emulsion was stored in a cool place at 8° C. For preparing microcapsules, the emulsion was heated to the room temperature (20-22° C.) and spray dried with a laboratory-scale spray dryer (Buechi Mini Spray Dryer B-191, Switzerland). Inlet and outlet temperatures were 170° C. and 90° C., respectively. Spraying pressure was kept at 5 bar. After this procedure, the rape seed oil was successfully microencapsulated and the final product (i.e. microcapsules) was a white, free flowing powder with a particle size of 1-2 μm (FIG. 3).

### EXAMPLE 11

Emulsion and Microencapsulation

Whey protein concentrate (75%) and ASWP fraction were used at a ratio of 70:20 to prepare 5% w/w aqueous solution. Rape seed oil was added 13% w/w (calculated from the solution weight) and the pH of the mixture was adjusted to pH 3.5 (1 M NaOH). The mixture was heated in the water bath up to 60° C., then homogenized for 1-2 minutes with Ultra Turrax to get an emulsion and finally passed through the FT-9 homogenizer three times. The emulsion was pasteurized at 75-78° C. for 5 minutes and cooled down to the room temperature (20-22° C.). The final emulsion was stored in a cool place at 8° C. For preparing microcapsules, the emulsion was warmed to the room temperature (20-22° C.) and spray dried with a pilot-scale spray dryer (Niro Spraydryer P-6.3, Denmark). Inlet and outlet temperatures were 160° C. and 80° C., respectively. Spraying pressure was kept at 125 mbar. After this procedure, the rape seed oil was successfully microencapsulated and the final product (i.e. microcapsules) was a white, free flowing powder with a particle size of 1 μm.

### EXAMPLE 12

Emulsion and Microencapsulation

Whey protein concentrate (75%) and ASWP fraction were used at a ratio of 70:25 to prepare 5% w/w aqueous solution. Cloudberry seed oil was added 13% w/w (calculated from the solution weight) and the pH of the mixture was adjusted to pH 6.0 (1 M NaOH). The mixture was heated in the water bath up to 60° C., then homogenized for 1-2 minutes with Ultra Turrax to get an emulsion and finally passed through the FT-9 homogenizer four times at pressure of 70 bar. The emulsion was pasteurized at 75-78° C. for 5 minutes and cooled down to the room temperature (20-22° C.). The final emulsion was stored in a cool place at 8° C. For preparing microcapsules, the emulsion was warmed to the room temperature (20-22° C.) and spray dried with a pilot-scale spray dryer (Niro Spraydryer P-6.3, Denmark). Inlet and outlet temperatures were 160° C. and 80° C., respectively. Spraying pressure was kept at 125 mbar. After this procedure, the cloudberry seed oil was successfully microencapsulated and the final product (i.e. microcapsules) was a red orange, free flowing powder with a particle size of <1 μm.

### EXAMPLE 13

Film Coating of Peanuts—Composition of the Coating Solution and Preparation of it

The ASWP content of the aqueous coating solution was 5% w/w. Glycerol 1% w/w (calculated from the solution weight) and sorbitol 1% w/w were used as plasticizers, and they were added and mixed with the solution. The pH of the plasticized solution was adjusted to pH 7.0 (1 M NaOH) and the solution was heated at 70° C. for one hour in the oven. The solution was then cooled down to the room temperature (20-22° C.). The final solution was stored in cool place at 8° C. for 5 months prior to use. Results of the respective film coating experiment are presented in Example 18.

### EXAMPLE 14

Series of Free Films

The ASWP fraction was used to prepare aqueous solutions. The solutions comprised ASWP 7.5% and 10% w/w, and glycerol 3% w/w and sorbitol 1% w/w as plasticizers (calculated from the solution weight). Titanium dioxide was added and mixed with some solutions at a level of 1% w/w in order to prevent sticking of the films. The solutions were heated at 70° C. for one hour in the oven (except one solution that was used without the heating treatment). The solutions were cooled down to the room temperature (20-22° C.) and poured into the Teflon molds. The films were dried at the horizontal level at 21° C./RH 45% for 24 hours (except the films that were made from the non-heated solution; the drying time for these films was 48 hours). The films were transparent and elastic.

TABLE 4
ASWP free film compositions.

Composition (%)

| | | | | Titanium |
|---|---|---|---|---|
| Exp. | ASWP | Glycerol | Sorbitol | dioxide |
| 1. | 7.5*¹ | 3 | 1 | — |
| 2. | 10.0*¹ | 3 | 1 | — |
| 3. | 7.5*¹ | 3 | 1 | 1 |
| 4. | 7.5*² | 3 | 1 | 1 |

*¹Heating 70° C. for one hour;
*²Without heating

The films were used in physical storage stability test and the results are presented in Example 23.

### EXAMPLE 15

Preparation of Coating Solutions

The ASWP fraction was used to prepare four aqueous coating solutions. The solutions comprised ASWP 5.0% w/w, and glycerol 1% w/w and sorbitol 1% w/w as plasticizers (calculated from the solution weight). The pH of the solutions was adjusted to pH 7.0 (1 M NaOH). The solutions were heated at 70° C. for one hour in the oven and subsequently cooled down to the room temperature (20-22° C.). The final coating solutions were stored in a cool place at 6-8° C. Solid coating adjuvants (magnesium stearate and titanium oxide) were added and the solution was homogenized thoroughly to form a milk-like dispersion. Magnesium stearate and titanium dioxide were added in three coating solutions at a level of 0.5-2% w/w in order to prevent sticking of the film coatings (see Table 5).

TABLE 5
ASWP film coating compositions.

| | Composition (%) | | | | | |
|---|---|---|---|---|---|---|
| | | | | Magn. | Titanium | Chinoline |
| Exp. | ASWP | Glycerol | Sorbitol | stearate | dioxide | yellow |
| 1. | 5 | 1 | 1 | — | — | — |
| 2. | 5 | 1 | 1 | 1 | 1 | — |
| 3. | 5 | 1 | 1 | 0.5 | 0.5 | 0.1 |
| 4. | 5 | 1 | 1 | 2 | 2 | 0.1 |

Results of the respective film coating experiments with the present coating compositions are presented in Example 21.

### EXAMPLE 16

Preparation of Capsule Shells

The solutions for preparing capsule shells comprised 9% w/w of protein (70% w/w of original whey protein concentrate and 30% w/w of ASWP), 4% w/w glycerol and 1% w/w sorbitol. The pH of the solution was adjusted to pH 5.0 (1 M NaOH). The solutions were heated at 70° C. for one hour in the oven and subsequently cooled down to the room temperature (20-22° C.). For preparing capsule shells, the solution was spray dried with a laboratory-scale spray dryer (Buch Mini Spray Dryer B-191, Switzerland). Inlet and outlet temperatures were 170° C. and 90° C., respectively. Spraying pressure was kept at 5 bar. The final solutions for preparing capsule shells were made from spray dried powders (concentration of protein 53.1% w/w). The solution contained 40% of protein (15 g of powder was dissolved to 20 ml purified water and the pH was adjusted to pH 6.5 by using 5 M NaOH). Protein was dissolved 0.5 grams at a time by simultaneously stirring (air bubbles were slightly formed). Capsule shell was prepared by dipping a rod into the solution and then the protein covered rod was dried for approximately 5 minutes using heated air in order to prevent flowing of the solution. Finally, the protein covered rod was allowed to dry for 4-5 hours at a room temperature (20-22° C.) and the capsule shell was ready to be pulled out of the surface of the rod

### EXAMPLE 17

Basic Model of the Baby's Milk Formula

Basic model of the baby's milk formula was prepared from the mixture of fat-free milk (Valio, Finland), precipitation fraction of whey proteins (P 13), rape seed oil (Raisio Yhtymä Oy, Finland) and lactose (JuustoKaira Oy, Finland).

The basic model of the baby's milk formula contained:

| | | |
|---|---|---|
| Protein | 1.5% | |
| Whey protein | 1.0% | |
| Casein | 0.5% | |
| Lipids (fat) | 3.5% | Rape seed oil |
| Carbohydrate | 7.3% | Lactose |

Precipitation fraction of the whey proteins acts as an emulsifier; no additional emulsifier is needed.

Fat-free milk contained:

| | |
|---|---|
| Protein | 3.3% |
| Casein | 2.5% |
| Whey proteins | 0.6% |
| Other nitrogen sources | 0.2% |
| Carbohydrates: | |
| Lactose | 4.9% |
| Lipids (fat) | 0% |

The precipitate fraction of whey proteins (P 13) contained:

| | | |
|---|---|---|
| Protein | 7.93% | 79.3 g/l |
| Dry substance | 8.92% | 89.2 g/l |
| Carbohydrates etc. | 0.85% | |
| Ash (salts) | 0.14% | |

Compounding of the basic model:

For preparing 20 liters of the basic model:

| | |
|---|---|
| Casein | 0.5% |

Casein is obtained from the fat-free milk (3.70 liters).

| | |
|---|---|
| Whey proteins | 1.0% |

3.70 liters of fat-free milk contains 22 grams of whey proteins. Since total 20 liters of 1.0% whey proteins contain 200 grams of protein, the need of proteins was 178 grams. Thus 2.25 liters of whey protein fraction (P 13) was needed.

| | |
|---|---|
| Lactose | 7.3% |

The amount of lactose in 3.70 liters of fat-free milk is 181 grams. For preparing 20 liters of basic model, total 1460 grams of lactose was needed. Thus the total amount of lactose to be added was 1.28 kg.

| | |
|---|---|
| Lipids (fat) | 3.5% |

Lipids (fat) were added in the form of rape seed oil. Total amount of rape seed oil needed was 35 g/l, thus the total need was 700 grams.

Preparation of Basic Model of the Baby's Milk Formula

Basic model was prepared in 40 liters vessels equipped with heating and stirring systems. The vessels were loaded with 12 liters of microfiltered water and heated up to 45° C. First, lactose (1.28 kg) was dissolved in the warm water. Then 2.25 liters of precipitation fraction was added and stirred until uniform suspension was obtained. The pH of the suspension was adjusted to pH 6.5 (4 N NaOH). After this 3.70 liters of fat-free milk was loaded to the vessel. Finally, rape seed oil (700 g or 800 ml) was added.

Suspension was vigorously stirred until the oil was dispersed homogeneously throughout the basic suspension. Then the suspension was heated up to 63° C. and stirred. Heated suspension was first homogenized at a pressure of 70 kg/cm² and the suspension turned to white fat milk-like product. Second homogenization was carried out by using the higher pressure of 120 kg/cm². The temperature was kept at 50° C. Immediately after homogenization, the product was pasteurized at 78° C. for approximately 35 seconds. After pasteurization, the pH of the suspension was 6.58. The relevant samples for chemical analysis were taken and the product was cooled down to 8° C. for storage.

Suspension (i.e. basic model of the baby's milk formula) was analyzed and the following characteristics were determined: amount of dry substance, protein content, sulfate ash, stability and hydrolysis of proteins. Stability of the product was determined at room temperature (22° C.) and at 8° C. For testing, 100 ml beakers (n=3) were loaded with the suspension and the beakers were kept at room temperature (22° C.) and at 8° C. for 24 hours and 2 weeks, respectively. Homogeneity and phase separation were visually inspected. At room temperature (22° C.), the suspension was kept stable for at least 24 hours and no phase separation was observed. At 8° C., the product remained stable for 2-4 weeks and no phase separation was observed.

The hydrolysis test simulating the GI tract conditions was performed with the basic model of the baby's milk formula (“O” product) by using the pepsin treatment at a pH of 2.0 for 3 hours and after that by trypsin treatment at a pH of 8.0 for 2 hours. The degree of hydrolysis was determined by using OPA method. As a reference, two commercial milk substitute products: baby's milk formulas “P” (powder) and “T” (ready-to-use product), were used.

TABLE 6
Degree of hydrolysis of the milk substitute products.

| Milk | | | | |
|---|---|---|---|---|
| substitute | Product (O, P, T) Hydrolysis % | | | |
| Time (h) | O | P | T | Treatment |
| 1 | 7.49 | 7.51 | 4.40 | Pepsin pH 2 |
| 2 | 10.43 | 7.91 | 7.00 | Pepsin pH 2 |
| 3 | 10.55 | 8.87 | 6.33 | Pepsin pH 2 |
| 3.5 | 17.95 | 15.05 | 9.69 | Trypsin pH 8 |
| 4 | 18.55 | 16.05 | 11.09 | Trypsin pH 8 |

### EXAMPLE 18

Method of ASWP Film Coating of Peanuts in a Side-Vented Drum Coater

Non-Pigmented Aqueous Solutions

Film Coating Procedure

Materials and preparation of film coating solution are described in Example 9. The ASWP content of the aqueous coating solution was 5% w/w, and glycerol and sorbitol were used as plasticizers (both at the level of 1% w/w). Peanuts with cover and without cover were used as cores for film coating.

For application and testing of the plasticized ASWP solutions for actual film coating of nuts, a laboratory-scale instrumented side-vented drum-coating apparatus (Thai coater, model 15, Pharmaceuticals and Medical Supply Ltd Partnership, Thailand) was used. For film coating, 900 g of nuts were weighed. Before starting the coating procedure the nuts were pre-heated for 5 minutes until the drum temperature was 40° C. Other process parameters were adjusted as follows: pump rate 2.2 rpm, spraying pressure 300 kPa, rotating speed of the drum 5 rpm, negative pressure in the drum −5 Pa, and flow rate of the outlet air 20 l/s. Coating solution was applied 221 g for the coating batch. After coating, the nuts were dried for 5 minutes at 40° C. in the drum-coater. Thereafter the nuts were kept at room temperature (25° C./RH 60%) for at least 24 hours before the film-coated nuts were studied.

By visual inspection, the ASWP film coatings of peanuts were satisfactory and they were not sticky. No technical drawbacks or difficulties were met in the film coating procedure of nuts with aqueous ASWP.

### EXAMPLE 19

Method of Preparation of ASWP Films and Film Forming Properties

Preparation and Characterization of Free Films

Free films of ASWPs plasticized with glycerol were prepared by the pouring technique. The compositions of the aqueous film forming solutions are prepared and described in Example 2 and are shown in Table 7.

TABLE 7
Compositions (in % w/w) of aqueous solutions of ASWPs.

| | Composition (%) | | | | | | | |
|---|---|---|---|---|---|---|---|---|
| Ingredient | 1*^{(a)} | 2*^{(a)} | 3*^{(b)} | 4*^{(b)} | 5*^{(c)} | 6*^{(c)} | 7*^{(d)} | 8*^{(d)} |
| ASWP | 3% | 4% | 3% | 4% | 3% | 4% | 3% | 4% |
| Glycerol | 1% | 2% | 2% | 1% | 2% | 1% | 1% | 2% |
| Purif. water | q.s. | q.s. | q.s. | q.s. | q.s. | q.s. | q.s. | q.s. |

*Film preparation temperatures and time: ^{(a)}70° C./10 min; ^{(b)}70° C./20 min; ^{(c)}80° C./10 min; ^{(d)}80° C./20 min

Films were held for 1 week at storage conditions of 25° C. (60% RH) before solid-state testing (by means of X-ray diffraction and atomic force microscopy, AFM) and subsequently for 1 month at 25° C. (60% RH) before physical appearance testing (scanning electron microscopy, SEM). The X-ray diffraction analyses of the samples were performed in symmetrical reflection mode with CuK_{α} radiation (1.54 Ångströms). The angular range was from 2° to 60° (at 2θ ) with steps of 0.02° and the measuring time was 20 s/step at all measurements. Atomic force microscope (AFM) analyses were conducted with Park Scientific Instruments Autoprobe CP (Thermomicroscopes, USA) with a Multitask-measuring head. Measurements were performed using IC-AFM (intermittent contact-AFM) mode. For the phase images the AFM was equipped with a M.A.P.®-module, which enables measurements of force moulding and phase separation signals. Scanning electron microscopy, SEM (Jeol JSM-840A, Jeol, Japan) was applied to characterize changes in physical appearance and morphology of the films stored for 1 month at 25° C./60% RH.

Morphology and Physical State of the Films

By visual inspection, the films prepared from ASWPs were transparent and clear being relatively easy to handle as they were not sticky. Short-term storage for 1 month at 25° C./60% RH did not affect physical appearance of the films (only slight brown color was observed). However, the films plasticized with 1% of glycerol and with the protein content of 4% (exp. 4 and 6) were clearly more brittle and fragile than the others thus showing not very satisfactory film properties. The fragility may be due to the insufficient amount of plasticizer used or the loss of glycerol (e.g. droplet forming) during the storage.

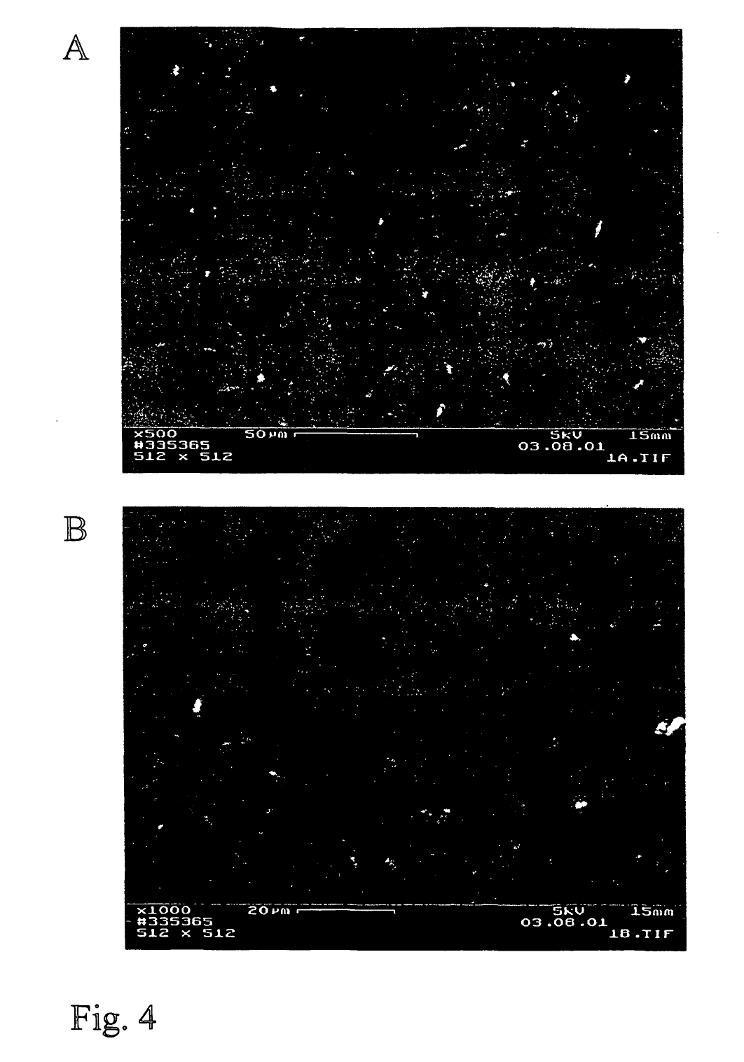

Scanning electron micrographs (SEMs) show that the morphology and physical structure of the films seem to be not very much dependent on the preparing conditions (temperature and time) of the films or the short-term storage (FIGS. 4A-H). As seen in the micrographs, the films plasticized with the larger amount of glycerol (2%), have less film surface defects compared with the others (Figs A, C, E, G). The films plasticized with smaller amount of glycerol (1%) have mainly relatively large irregular spots or fragments (Figs A, D, F, G). SEMs show that the films prepared by using a longer period of curing time (20 min) are mainly homogeneous but such films plasticized with lower amount of glycerol (1%) have also a tendency to fragmentate.

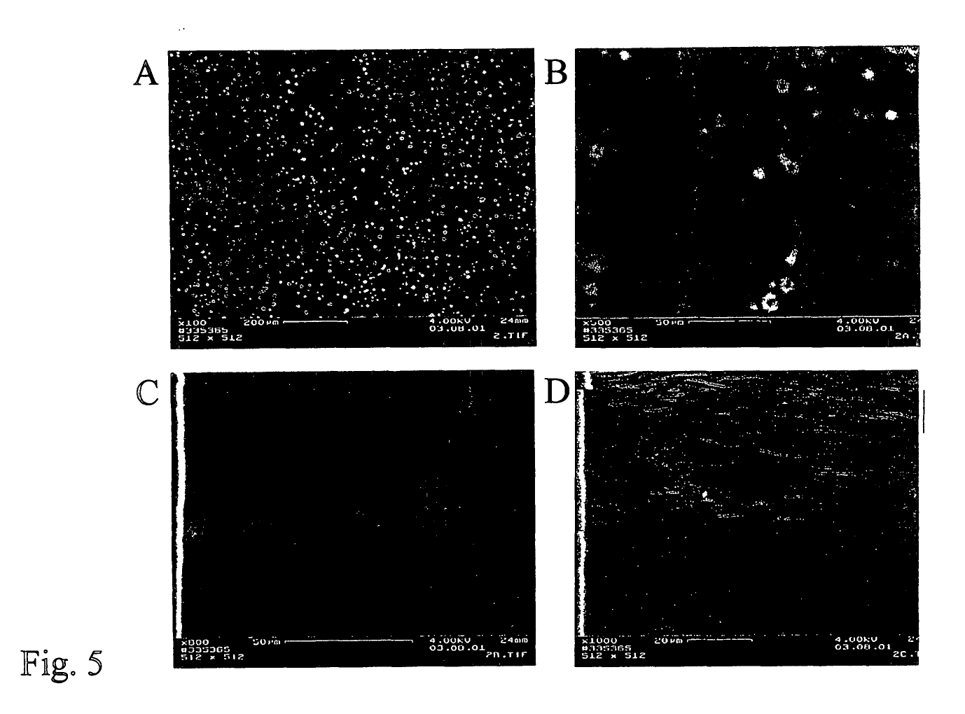

The X-ray diffraction results showed an absence of any crystallinity in the present ASWP films stored for approximately 1 week at 25° C./60% RH (i.e. no signal peaks of crystallinity were seen in the X-ray diffraction patterns). Thus, the present films seem to have a highly amorphous film structure giving an evidence of a disordered placement of the film former in a film matrix. Atomic force micrographs (AFMs) show that three phases can be observed in all batches. The droplets seem to be largest in batches 1 and 2, and smallest in batches from 3 to 7. Medium treatment seems to give smaller droplets (FIG. 5). No correlation was seen between the film composition/curing conditions and the amount of large dots (evaluated from 60×60 μm, smaller dots (evaluated from small images) and holes.

### EXAMPLE 20

Method of ASWP Film Coating of Tablets in a Side-Vented Drum Coater

Non-Pigmented Aqueous Solutions

Film Coating Procedure

Materials and preparation of film coating solution and/or dispersion are described in Example 4. As seen in Tables 2 and 3, the ASWP content of the aqueous coating solutions were 5% and 6%. The plasticizers, glycerol and sorbitol and mixtures of them (1:1), were added and mixed with the solution. The coating solution was kept in the water bath at 75° C. for 15 minutes prior to use (preheating; see Tables 2 and 3).

The tablet cores (substrates) contained: theophylline (Ph.Eur.) 5%, lactose mono-hydrate 30%, microcrystalline cellulose 56%, talc 8% and magnesiumstearate 1%.

For application and testing of the plasticized ASWP solutions for actual film coating of tablets, a laboratory-scale instrumented side-vented drum-coating apparatus (Thai coater, model 15, Pharmaceuticals and Medical Supply Ltd Partnership, Thailand) was used. For film coating, 1000 g of tablet cores were weighed. Before starting the coating procedure the tablets were pre-heated for 10 minutes until the drum temperature was 40° C. Coating solution was applied 325 g for each coating batch. After coating, the tablets were dried for 5 minutes at 40° C. in the drum-coater. Other coating parameters are presented in Table 8. Thereafter the tablets were kept at room temperature (25° C./RH 60%) for at least 24 hours before the film-coated tablets were studied.

The responses evaluated were appearance of the film-coated tablets (visually and with a stereomicroscope), tablet weight and weight variation (n=20), radial breaking strength (Schleuniger; n=10), dissolution with a Ph.Eur. paddle method (n=6) and dimensions of the tablets before and after film coating measured by a micrometer (Sony Inc., Japan; n=10).

The experimental designs presented in Example 4 (in Tables 2 and 3) were applied in the film coating study, and the experiments were performed in randomized order (ref. is made to Example 5).

TABLE 8
Coating parameters.

| Process parameter | Part 1 | Part 2 |
|---|---|---|
| Pump rate of the coating | 3.5 (=2.2 rpm) | 5.0 (=3.0 rpm) |
| solution (g/min) | | |
| Spraying pressure (kPa) | 300 | 300 |
| Drum temperature (° C.) | 40 | 50 |
| Rotating speed of the | 7 | 5 |
| drum (rpm) | | |
| Negative pressure in the | −5 | −5 |
| drum (Pa) | | |
| Flow rate of the outlet | 18 | 18 |
| air (l/s) | | |

Applicability of ASWP Solutions in the Coating Process

Overall, neither significant technical drawbacks nor difficulties were met in the film coating procedure of tablets with aqueous whey protein solutions. With the coating batches tested in Part 1, virtually no sticking of the tablets on the drum walls was observed during the coating operations. It should be pointed out that slight mechanical erosion and friability of the tablet cores partly affected the quality of the final film coatings of the tablets.

As regards with the film coating experiments performed in Part 2, the process applicability of the coating formulations tested are summarized in Table 9.

TABLE 9
Applicability of the whey protein coating
solutions in the process (Part 2).

| | Composition (%) | | | Description of the coating process (drum |
|---|---|---|---|---|
| Exp. | ASWP | Gly | Sor | speed 5 rpm/50° C.; pump rate 3.0 rpm) |
| 1.* | 5 | 1 | 1 | No technical problems. |
| 2. | 5 | 1 | 1 | Slight sticking and adhesion of the |
| | | | | tablets on the wall of the coating drum |
| | | | | (especially in the end of the coating |
| | | | | procedure). |
| 3.* | 6 | 1.2 | 1.2 | Clear sticking and adhesion of the |
| | | | | tablets (numerous tablets adhered on the |
| | | | | wall of the drum). The composition not |
| | | | | applicable. |
| 4. | 6 | 1.2 | 1.2 | Clear sticking and adhesion of the |
| | | | | tablets |

*No preheating of the coating solution.

Characterization of Film-Coated Tablets

As seen in Table 10, appearance of the film-coated tablets varied greatly suggesting differences in the applicability of the different coating compositions and also sensitivity of the coating formulations to process conditions. The best and most satisfactory results were obtained with the coating composition 4 comprising 5% of the whey protein and 1% of plasticizers (glycerol and sorbitol) at a ratio of 1:1.

TABLE 10
Appearance of film-coated tablets following visual inspection
(quality rank points are given from 0 to 10).

| | Composition (%) | | | Appearance* |
|---|---|---|---|---|
| Exp. Part 1 | ASWP | Glycerol | Sorbitol | (rank points 0-10) |
| 1. | 5 | 0 | 0 | 4 |
| 2. | 5 | 1 | 0 | 4 |
| 3. | 5 | 0 | 1 | 6 |
| 4. | 5 | 1 | 1 | 7 |
| 5. | 5 | 2 | 0 | 4 |
| 6. | 5 | 0 | 2 | 4 |
| 7. | 5 | 2 | 2 | 1 |
| 8. | 5 | 3 | 0 | 1 |
| 9. | 5 | 0 | 3 | 6 |
| 10. | 5 | 3 | 3 | 0 |

*It should be pointed out that slight mechanical erosion and friability of the present tablet cores affected the quality of the final film-coatings.

Weight increase and uniformity of weight of whey protein coated tablets were very satisfactory with all batches tested suggesting good performance of the coating solutions in the process (Table 11).

TABLE 11
Weight and weight variation of film-coated tablets (n = 20).

| | | | | Mean weight and weight | | |
|---|---|---|---|---|---|---|
| | | | | variation | | |
| Exp. | Composition (%) | | | Mean | | |
| Part 1 | ASWP | Glycerol | Sorbitol | (mg) | S.D. | RSD % |
| Tablet | — | — | — | 498.7 | 3.8 | 0.8 |
| core | | | | | | |
| 1. | 5 | 0 | 0 | 509.6 | 9.8 | 1.9 |
| 2. | 5 | 1 | 0 | 507.5 | 3.2 | 0.6 |
| 3. | 5 | 0 | 1 | 507.8 | 4.8 | 1.0 |
| 4. | 5 | 1 | 1 | 509.6 | 4.0 | 0.8 |
| 5. | 5 | 2 | 0 | 508.6 | 12.8 | 2.5 |
| 6. | 5 | 0 | 2 | 511.7 | 4.3 | 0.8 |
| 7. | 5 | 2 | 2 | 512.9 | 3.0 | 0.6 |
| 8. | 5 | 3 | 0 | 515.7 | 4.5 | 0.9 |
| 9. | 5 | 0 | 3 | 510.1 | 5.7 | 1.1 |
| 10. | 5 | 3 | 3 | 518.4 | 6.0 | 1.2 |

Mechanical strength of the coated tablets was relatively high but mechanical strength was not increased compared to that obtained with tablet cores. Uniformity of the breaking strength values of the tablets, however, was good with exception of two batches providing an evidence of satisfactory film coating of the tablets with aqueous ASWPs (Table 12).

TABLE 12
Mechanical strength of film-coated tablets (n = 10).

| | | | | Mechanical strength | | |
|---|---|---|---|---|---|---|
| Exp. | Composition (%) | | | Mean | | |
| Part 1 | ASWP | Glycerol | Sorbitol | (N) | S.D. | RSD % |
| Tablet | — | — | — | 99.6 | 4.3 | 4.3 |
| core | | | | | | |
| 1. | 5 | 0 | 0 | 86.1 | 19.3 | 22.5 |
| 2. | 5 | 1 | 0 | 81.6 | 3.4 | 4.1 |
| 3. | 5 | 0 | 1 | 77.5 | 5.3 | 6.9 |
| 4. | 5 | 1 | 1 | 81.9 | 5.3 | 6.4 |
| 5. | 5 | 2 | 0 | 77.6 | 6.0 | 7.8 |
| 6. | 5 | 0 | 2 | 74.9 | 5.6 | 7.5 |
| 7. | 5 | 2 | 2 | 76.4 | 4.6 | 6.0 |
| 8. | 5 | 3 | 0 | 78.9 | 6.7 | 8.5 |
| 9. | 5 | 0 | 3 | 87.8 | 11.0 | 12.5 |
| 10. | 5 | 3 | 3 | 78.9 | 5.4 | 6.8 |

The ASWP-coated tablets can be classified as immediate-release tablets since drug release (theophylline) was very rapid (t50% values below 10 min) with all batches tested (Table 13). The dissolution of the present film coating seems to be also independent from the environmental pH in the range of pH values from pH 1.2 to 6.8.

TABLE 13
Dissolution of film-coated tablets (n = 6).

| | | | | T50% (min) | | |
|---|---|---|---|---|---|---|
| | | | | | 0.1 N | |
| Exp. | Composition (%) | | | 0.1 N | HCl + | |
| Part 1 | ASWP | Glycerol | Sorbitol | HCl | pepsin | pH 6.8 |
| Tablet | — | — | — | 3.0 | * | 3.2 |
| core | | | | | | |
| 1. | 5 | 0 | 0 | 4.9 | * | — |
| 2. | 5 | 1 | 0 | 7.3 | * | 4.9 |
| 3. | 5 | 0 | 1 | 5.0 | * | — |
| 4. | 5 | 1 | 1 | 3.3 | * | — |
| 5. | 5 | 2 | 0 | 3.3 | * | — |
| 6. | 5 | 0 | 2 | 4.8 | * | 5.0 |
| 7. | 5 | 2 | 2 | — | * | — |
| 8. | 5 | 3 | 0 | 7.5 | * | — |
| 9. | 5 | 0 | 3 | 3.6 | * | 3.0 |
| 10. | 5 | 3 | 3 | 3.4 | * | — |

### EXAMPLE 21

Method of ASWP Film Coating of Tablets in a Side-Vented Drum Coater

Pigmented Aqueous Dispersions

Film Coating Procedure

Materials and preparation of coating dispersions, composition of the tablet cores (substrates) and film coating process and equipment, are described in Example 16. The compositions of the pigmented coating dispersions are shown in Table 14. The ASWP content of the dispersions was 5% (w/w). A mixture of glycerol and sorbitol as a plasticizer and at a weight ratio of 1:1 was added and mixed with the protein-containing solution. Solid coating adjuvants (magnesium stearate and titanium oxide) were added and the solution was homogenized thoroughly to form a milky like dispersion. The total amount of coating dispersion applied onto the tablets was approximately 600 g.

TABLE 14
Composition of the pigmented coating dispersions.

| | Composition (%) | | | | | |
|---|---|---|---|---|---|---|
| | | | | Mg. | Titanium- | Chinoline |
| Exp. | ASWP | Glycerol | Sorbitol | stear. | dioxide | yellow |
| 1. | 5 | 1 | 1 | — | — | — |
| 2. | 5 | 1 | 1 | 1 | — | — |
| 3. | 5 | 1 | 1 | 0.5 | 0.5 | 0.1 |
| 4. | 5 | 1 | 1 | 2 | 2 | 0.1 |

TABLE 15
Coating parameters.

| Process parameter | Exp. 1 and 3 | Exp. 2 and 4 |
|---|---|---|
| Pump rate of the coating solution | 3.5 (=2.2 rpm) | 3.5 (=2.2 rpm) |
| (g/min) | | |
| Spraying pressure (kPa) | 300 | 300 |
| Drum temperature (° C.) | 40 | 40 |
| Rotating speed of the drum (rpm) | 8* | 8** |
| Negative pressure in the drum (Pa) | −5 | −5 |
| Flow rate of the outlet air (l/s) | 20 | 20 |

*Preheating at a rate of 3 rpm and early-stage coating phase 5 rpm for 10 to 15 min.
**Preheating at a rate of 3 rpm and early-stage coating phase 5 rpm for 5 min.

The responses evaluated were appearance of the coated tablets (visually and with a stereo-microscope), tablet weight and weight variation (n=20), radial breaking strength (Schleuniger; n=10), disintegration in vitro (Ph.Eur.; n=6) and dimensions of the tablets before and after film coating measured by a micrometer (Sony Inc., Japan; n=10).

Applicability of the Pigmented Dispersions in the Coating Process

In general, neither significant technical drawbacks nor difficulties were met in the film coating procedure of tablets with the present aqueous ASWP dispersions. With all batches studied, however, slight sticking and adhesion of the tablets on the drum walls was observed during the coating procedure. This occurred especially when over 300 g of the coating dispersion was applied (e.g. after approx. 90 minutes from the start point). If this adhesion phenomena is compared to that observed with the previous coating formulations containing no magnesium stearate, adhesion occurred to a much smaller extent. Addition of magnesium stearate in coating compositions clearly prevents the adhesion of the tablets, and thus facilitates the film coating procedure. It should be pointed out that slight mechanical erosion and friability of the tablet cores partly affected the quality of the final film coatings.

Characterization of Film-Coated Tablets

The quality rank points for the appearance of film-coated tablets are summarized in Table 16.

TABLE 16
Appearance of film-coated tablets following visual inspection
(quality rank points are given from 0 to 10).

| | | | | | | | Appear- |
|---|---|---|---|---|---|---|---|
| | | | | | | | ance |
| | Composition (%) | | | | | | (0-10 |
| | | | | Mg. | Titanium | Chinoline | rank |
| Exp. | ASWP | Gly | Sorb | stear. | dioxide | yellow | points) |
| 1. | 5 | 1 | 1 | — | — | — | 2* |
| 2. | 5 | 1 | 1 | 1 | — | — | 7 |
| 3. | 5 | 1 | 1 | 0.5 | 0.5 | 0.1 | 6 |
| 4.* | 5 | 1 | 1 | 2 | 2 | 0.1 | 4* |

*Clear sticking and adhering of tablets were observed at the end of coating process.

To study the progress of film coating and the film quality, a sample of 20 tablets was taken at 20, 40, 60, 80, 100, 120, 140 and 160 min after initiating the coating process (Exp. 4). The results are presented in Table 17.

TABLE 17
Appearance and film coating quality of tablets observed during the
coating procedure (quality rank points are given from 0 to 10).

| | Sampling protocol | | | | |
|---|---|---|---|---|---|
| | | | Theoretical amount | | Appearance |
| | Coating | Amount of coat- | of film coat | | (from 0 to |
| Exp. | time | ing dispersion | (whey protein) | | 10 quality |
| 4 | (min) | applied (g) | % | mg/cm² | rank points) |
| a. | 20 | 65.0 | 0.3 | 0.6 | 9 |
| b. | 40 | 135.1 | 0.7 | 1.1 | 8 |
| c. | 60 | 208.3 | 1.0 | 1.8 | 7 |
| d. | 80 | 285.1 | 1.4 | 2.4 | 7 |
| e. | 100 | 360.7 | 1.8 | 3.1 | 6 |
| f. | 120 | 435.6 | 2.2 | 3.7 | 6 |
| g. | 140 | 570.0 | 2.8 | 4.8 | 5 |
| h. | 160 | approx. 600 | 3.0 | 5.1 | 4 |

TABLE 18
Weight and weight variation of film-coated tablets (n = 10).

| | | | | | | Mean and standard | | |
|---|---|---|---|---|---|---|---|---|
| | Composition (%) | | | | | dev. (n = 10) | | |
| | | | | Mg. | Titan. | Mean | | |
| Exp. | ASWP | Gly | Sorb | stear. | dioxide | (mg) | S.D. | RSD % |
| Tablet | — | — | — | — | — | 498.7 | 3.8 | 0.8 |
| core | | | | | | | | |
| 1. | 5 | 1 | 1 | — | — | 517.5 | 3.7 | 0.7 |
| 2. | 5 | 1 | 1 | 1 | — | 521.0 | 4.4 | 0.8 |
| 3. | 5 | 1 | 1 | 0.5 | 0.5 | 518.4 | 4.0 | 0.8 |
| 4. | 5 | 1 | 1 | 2 | 2 | 522.4 | 2.7 | 0.5 |

TABLE 19
Mechanical strength of film-coated tablets (n = 10).

| | | | | | | Mean and standard | | |
|---|---|---|---|---|---|---|---|---|
| | Composition (%) | | | | | dev. (n = 10) | | |
| | | | | Mg. | Titan. | Mean | | |
| Exp. | ASWP | Gly | Sorb | stear. | dioxide | (N) | S.D. | RSD % |
| Tablet | — | — | — | — | — | 99.6 | 4.3 | 4.3 |
| core | | | | | | | | |
| 1. | 5 | 1 | 1 | — | — | 93.7 | 5.9 | 6.3 |
| 2. | 5 | 1 | 1 | 1 | — | 85.6 | 3.8 | 4.4 |
| 3. | 5 | 1 | 1 | 0.5 | 0.5 | 79.3 | 7.1 | 8.9 |
| 4. | 5 | 1 | 1 | 2 | 2 | 105.1 | 5.1 | 4.8 |

TABLE 20
In vitro disintegration of film-coated tablets (n = 3-6).

| | Composition (%) | | | | | |
|---|---|---|---|---|---|---|
| | | | | Mg. | Titan. | Disintegration time |
| Exp. | ASWP | Gly | Sorb | stear. | dioxide | in vitro (n = 3-6) |
| Tablet | — | — | — | — | — | <0.5 min |
| core | | | | | | |
| 1. | 5 | 1 | 1 | — | — | <1 min |
| 2. | 5 | 1 | 1 | 1 | — | <1.5 min |
| 3. | 5 | 1 | 1 | 0.5 | 0.5 | <1.5 min |
| 4. | 5 | 1 | 1 | 2 | 2 | <1.5 min |

### EXAMPLE 22

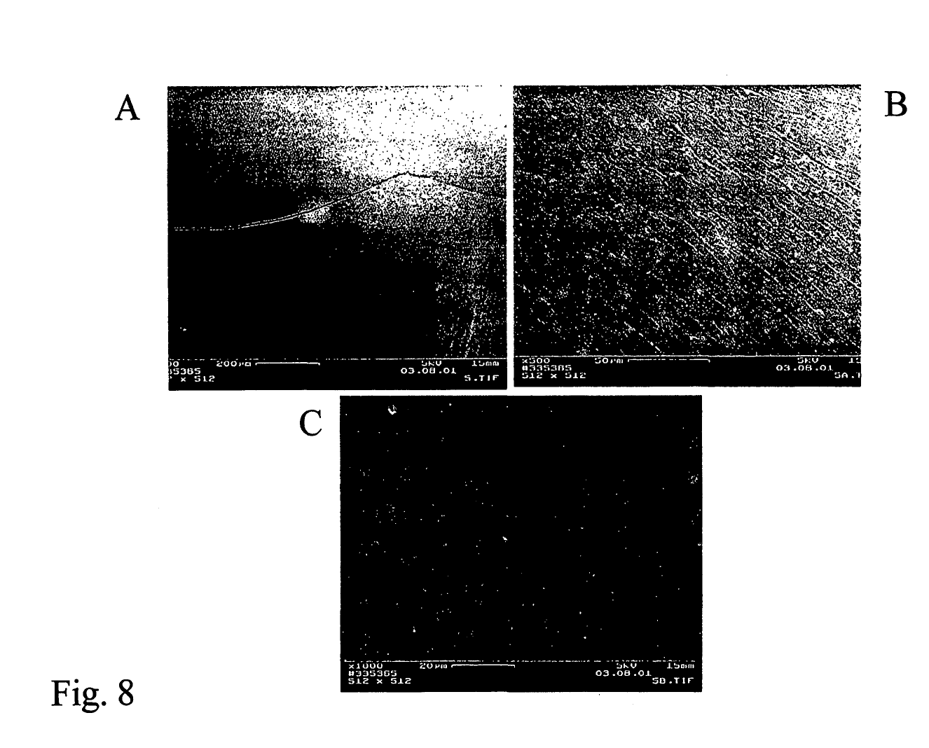

Free films of ASWPs containing maltodextrin as an adjuvant were prepared by pouring the plasticized solution into the molds and subsequently drying and peeling the films. The films were plasticized with glycerol and sorbitol. As seen in FIG. 8, the films contained tiny pores but it was evident that inclusion of maltodextrin results in significant increase in the mechanical strength of the films.

### EXAMPLE 23

Physical Storage Stability of Free Films and Coated Tablets

Solid-State Characterization of Free Films

Free films of ASWPs plasticized with glycerol and sorbitol were prepared by the pouring technique. The compositions of the aqueous film forming solutions are shown in Table 21.

TABLE 21
Compositions (in % w/w) of aqueous solutions of ASWPs.

Composition (%)

| Ingredient | 1*^{(a)} | 2*^{(a)} | 3*^{(a)} | 4*^{(b)} |
|---|---|---|---|---|
| ASWP | 7.5% | 10% | 7.5% | 7.5% |
| Glycerol | 3% | 3% | 3% | 3% |
| Sorbitol | 1% | 1% | 1% | 1% |
| Titanium dioxide | — | — | 1% | 1% |
| Purif. water | q.s. | q.s. | q.s. | q.s. |

*Treatment of the ASWP liquid before use: ^{(a)}70° C./1 h; ^{(b)}no heating

Film samples were held for up to 6 months at storage conditions of 25° C. (60% RH) and 50° C. Sampling time points were 1, 3 and 6 months. For physical storage stability testing, the X-ray diffraction and MR analyses of the samples were performed as described previously.

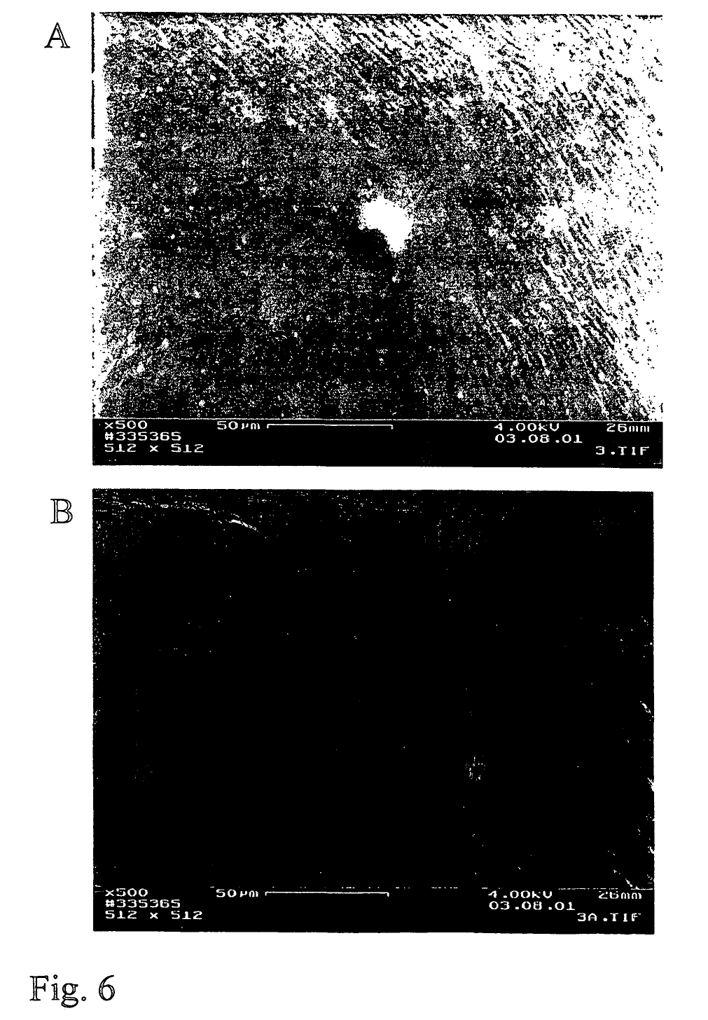

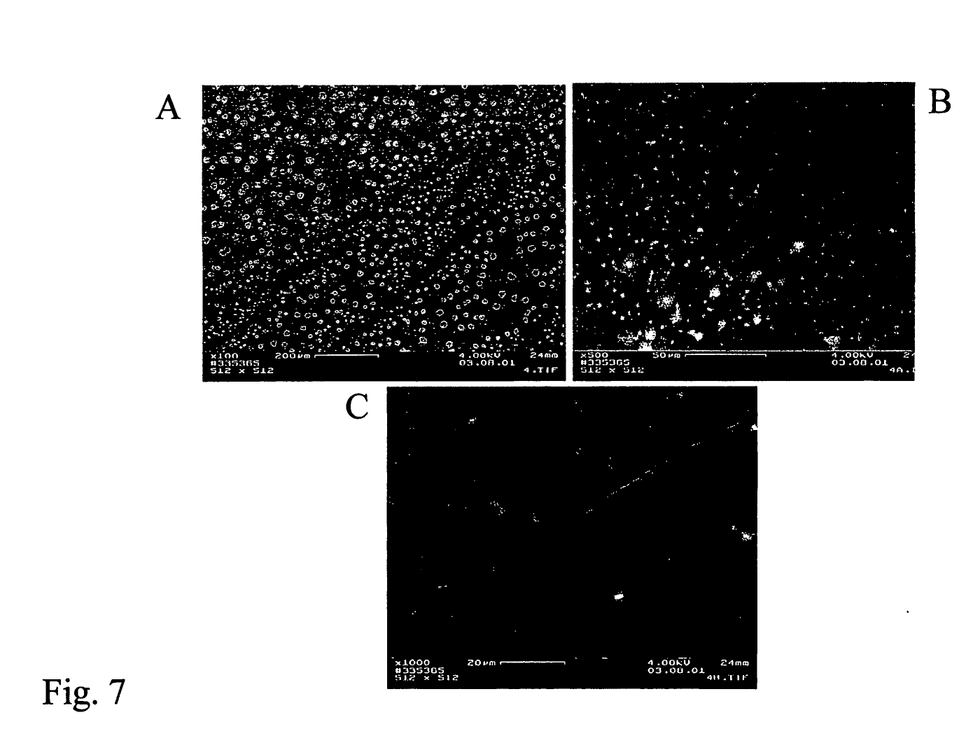

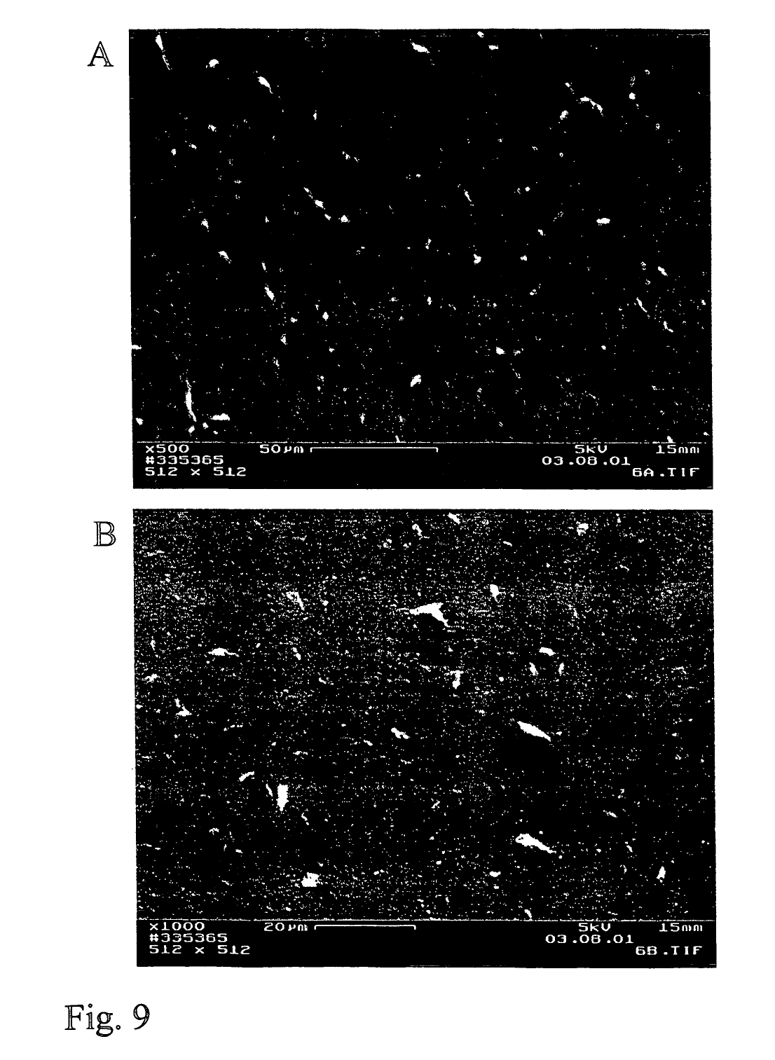

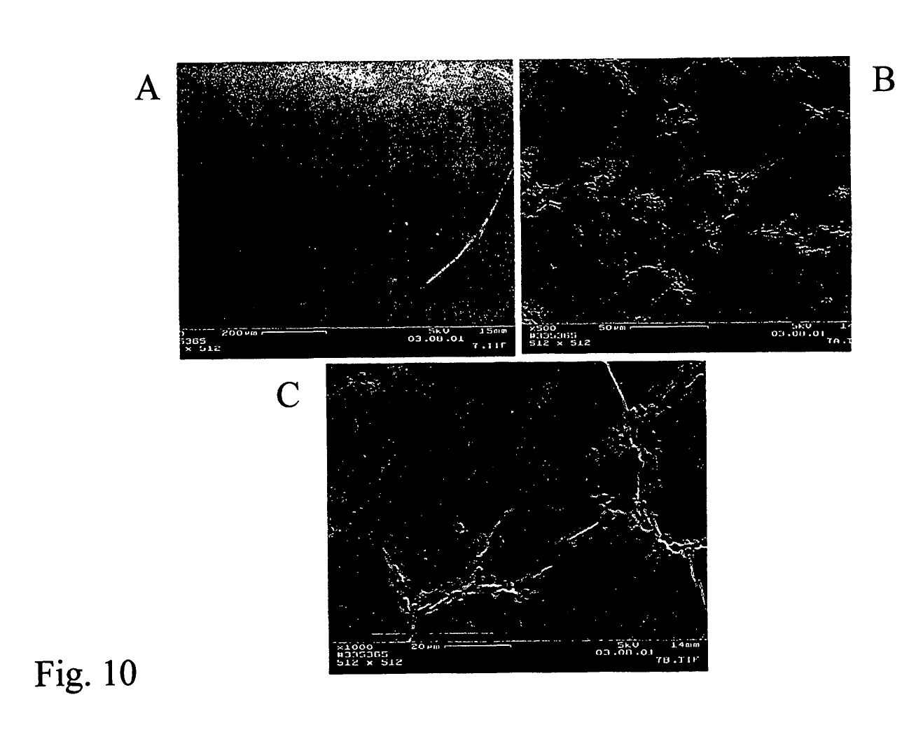

Scanning electron micrographs (SEMs) on fresh reference ASWP films show that the films are homogeneous and of good quality (FIGS. 6 and 7). The results of the storage stability study are presented in FIGS. 9 and 10. The X-ray diffraction results showed an absence of any crystallinity in the ASWP films (exp. 1 and 2) and no additional crystallinity in the pigmented ASWP films (exp. 3 and 4) compared to that obtained with the fresh films (i.e. no signal peaks of crystallinity were seen in the X-ray diffraction patterns). Thus, the present ASWP films seem to be physically very stable systems suggesting applicability in their final use. Due to the extremely stressed conditions at 50° C. clear changes in physical appearance and toughness of the films, however, were observed.

This invention has been described with an emphasis upon some of the preferred embodiments and applications. However, it will be apparent for those skilled in the art that variations in the preferred embodiments can be prepared and used and that the invention can be practiced otherwise than as specifically described herein within the scope of the following claims.

1. A protein-based film comprising a protein network formed by disulfide bonds between the proteins comprising a protein network which has been formed by treating proteins with modified protein in a solution, which protein has been modified by cleaving at least one disulfide bond originally present in said protein by sulfitolysis to obtain free sulfhydryl groups, whereupon an interchange reaction by said free sulfhydryl groups has occurred forming said disulfide bonds between the proteins, wherein the pH of said solution was 7 or below.

2. A protein-based film of claim 1, wherein said film has been formed without heat treatment.

3. The protein-based film of claim 1 wherein the amount of free sulfhydryl groups in the total protein of the solution before the interchange reaction was 0.5-60 μmol/g protein.

4. The protein-based film of claim 1 wherein said modified protein comprises whey protein, such as the soluble fraction or precipitate fraction of modified whey protein or combinations thereof.

5. The protein-based film of claim 1 wherein said protein has been sulfonated by said sulfitolysis by contacting it with sulfite ion forming agent, such as alkali metal or earth alkali metal sulfite, hydrogen sulfite or metabisulfite, or combinations thereof.

6. The protein-based film of claim 1 wherein the film further contains at least one of a strength-improving agent, such as carbohydrate, such as maltodextrin or other starch hydrolysate;
a plasticizer or lipophilic compound, such as stearate, butter fat as oil or true oil or combinations thereof; and,
a pigment dye, such as titanium oxide, antiadhesive agent, antimicrobial agent or preservative agent.

7. The protein-based film of claim 6, wherein said film remains substantially intact in 0.1 M HCl (pH 2) at 37° C. for at least 6 hours before dissolving.

8. The protein-based film of claim 6, wherein said film remains substantially intact in 0.1 M HCl (pH 2) containing 0.1% pepsin at 37° C. for at least 30 minutes before dissolving.

9. (canceled)

10. (canceled)

11. The protein-based film of claim 1 wherein said film has been formed on a substance to coat the substance.

12. The protein-based film of claim 11, wherein said substance is a food product.

13. The protein-based film of claim 11, wherein said substance is a tablet, granule, pellet or the like containing therapeutically active agent.

14. The protein-based film of claim 1 wherein said film has been formed as a capsule shell.

15. The protein-based film of claim 1 wherein said film has been formed around lipid, oil, lipophilic compound or combinations thereof to form an emulsion or microcapsule.

16. A food product, characterized in that has been coated with or contains substances coated with a film of claim 1.

17. A baby's milk formula, characterized in that it contains film of claim 6 as an emulsion.

18. A pharmaceutical product containing at least one therapeutically active agent, characterized in that has been coated with a film of claim 1.

19. A container characterized in that has been coated with the film of claim 1.

20. Method for preparing a protein-based film comprising a protein network formed by disulfide bonds between the proteins, comprising
providing an amount of protein solution containing modified protein, which has been modified by cleaving at least one disulfide bond originally present in said protein by sulfitolysis to obtain free sulfhydryl groups, which are able to cause an interchange reaction for form disulfide bonds between the proteins, and
forming said solution into said protein-based film, wherein the pH of said solution is 7 or below.

21. The method of claim 20, comprising forming said film without heat treatment.

22. The method of claim 20 wherein the amount of the free sulfhydryl groups in the total protein of the solution before the interchange reaction is 0.5-60 μmol/g protein.

23. The method of claim 20 wherein said protein has been sulfonated in said sulfitolysis by contacting it with sulfite ion forming agent.

24. The method of claim 23, wherein said sulfite ion forming agent comprises alkali metal or earth alkali metal sulfite, hydrogen sulfite or metabisulfite or combinations thereof.

25. The method of claim 24, wherein the amount of sulfite used is 0.01-0.06% (w/v).

26. The method of claim 20 wherein said modified protein comprises whey protein, such as the soluble fraction or precipitate fraction of modified whey protein or combinations thereof.

27. The method of claim 20 including further adding at least one of a plasticizer or lipophilic compound, such as stearate, butter fat as oil or true oil, or combinations thereof;
a strength-improving agent, such as carbohydrate, such as maltodextrin or other starch hydrolysate; and
a pigment dye, such as titanium oxide, antiadhesive agent, antimicrobial agent or preservative agent.

28. (canceled)

29. (canceled)

30. The method of claim 20 including forming the film on a substance to coat the substance.

31. The method of claim 30, wherein said substance is a food product.

32. The method of claim 30, wherein said substance is a tablet, granule, pellet or the like containing therapeutically active agent.

33. The method of claim 20 including forming the film as a capsule shell.

34. The method of claim 20 including forming the film around lipid, oil, lipophilic compound or combinations thereof to form an emulsion or microcapsule.
